(19) United States
(12) Patent Application Publication
(10) Pub. No.: US 2011/0060578 A1
(43) Pub. Date: Mar. 10, 2011

(54) COMPREHENSIVE MODELING OF THE HIGHLY NETWORKED COAGULATION-FIBRINOLYSIS-INFLAMMATORY-IMMUNE SYSTEM

(75) Inventors: Kevin Ward, Richmond, VA (US); Umesh R. Desai, Glen Allen, VA (US); Nathan Menke, Richmond, VA (US); Lemont B. Kier, Richmond, VA (US); C.K. Cheng, Richmond, VA (US)

(73) Assignee: Virginia Commonwealth University, Richmond, VA (US)

(21) Appl. No.: 12/919,529

(22) PCT Filed: Mar. 3, 2009
(86) PCT No.: PCT/US09/35866

§ 371 Date: Nov. 23, 2010

Related U.S. Application Data
(60) Provisional application No. 61/033,138, filed on Mar. 3, 2008.

(51) Int. Cl. G06G 7/60

(52) U.S. Cl. 703/11

(57) ABSTRACT

An agent-based modeling system (ABMS) is employed to quantitatively analyze individual components of each system of the coagulation-immune/inflammatory-fibrinolysis system at every point of simulation. ABMS is a dynamic modeling and simulation tool that allows the study of dynamic non-linear networked systems. ABMS represents a non-reductionist approach of studying the biologic process as a whole, while retaining information at the level of an individual component.

### CROSS-REFERENCES TO RELATED APPLICATIONS

This application claims priority to and the benefit under 35 U.S.C. §119(e) to provisional application Ser. No. 61/033,138, filed on Mar. 3, 2008, the disclosure of which is herein expressly incorporated by reference in its entirety.

### BACKGROUND OF THE INVENTION

1. Field of the Invention

The invention generally relates to agent-base modeling of the coagulation-inflammatory/immune-fibrinolysis system.

2. Related Art

Mathematical systems biology is an emerging field of understanding physiological processes through computational tools. A phenomenal advantage of this approach is its rapid, real time analysis of multiple biological systems, each of which is a highly co-ordinated independent network that interacts with others in the group at one or more branch points. These independent networks can be thought of as small molecular machines, which work co-operatively to form a giant molecular system that produces one or more physiological response. Understanding the mechanism and co-operativity of these networks with the goal of predicting the physiological response, in the presence and absence of appropriate pharmaceutical agents, is an extremely difficult and intricate task, as such a computational tool would have practical applications in understanding pathological and physiological conditions and being able to design personalized and tailored treatment for patients.

Understanding gained at a molecular level in the past decade suggests that three highly networked systems—the blood coagulation system, the fibrinolysis system and the inflammatory/immune response system—interact with each other extensively through multiple branch points. While each system is understood at a molecular level in sufficient detail, the manner and extent to which these systems interact with each other is unknown. More importantly, the pathological and physiological conditions induced in one system due to dysfunction in another remains unclear. Finally, the effect of pharmaceutical modulation of one system inducing changes in the other remains unaddressed.

The highly complex coagulation-immune/inflammatory-fibrinolysis system presents a challenging problem of identifying the root cause of many known defects. To date the contribution of each system as a part of the network has not been attempted. Accordingly, it would be desirable to have a computer model that can simulate the highly networked coagulation-immune/inflammatory-fibrinolysis system.

### BRIEF SUMMARY OF THE INVENTION

The invention provides methods, systems and apparatus for developing an agent-based modeling system to model the coagulation-immune/inflammatory-fibrinolysis system. The invention may be implemented in a number of ways, including those described below.

According to one aspect of the invention, a computer system for modeling the coagulation-fibrinolysis-inflammation/immune (CIF) system may include one or more processors, and a computer readable medium in communication with the one or more processors, the computer readable medium may have encoded thereon a set of instructions executable by the computer system to perform one or more operations, instructions for arranging the plurality of agents in a computer model, the computer model including a plurality of cells and a set of rules that govern behavior of each of the plurality of agents, where each cell may represent a discrete unit of space, and instructions for iteratively applying the set of rules to the plurality of agents to simulate the CIF system. The set of instructions may include instructions for identifying a plurality of agents involved in the CIF system, where each agent may represent a molecule in the CIF system and may be defined by an identifier and an interaction probability value. The identifier may have a value that identifies a type of molecule represented by the agent, and the interaction probability value may represent a probability that the agent will react with a neighboring agent.

Each of the plurality of agents may have an identifier that identifies that the agent represents one or more molecular or cellular agents of the CIF system such as a substrate, an enzyme, a reaction product, an inhibitor, a cofactor, endothelial cell, white blood cells, platelets red blood cells, cell membrane receptors, cytokines, chemokines, biological cells, bacteria, viruses, transcription factors, coagulation factors, second messengers, exogenous anticoagulant factors, exogenous procoagulant factors, and a water molecule. The computer readable medium may be an optical magnetic storage device, a magnetic storage device or a disk. Each cell may represent a discrete unit of space in one, two, or three dimensions. The plurality of cells may be arranged in a two or three dimensional grid.

According to another aspect of the invention, a method for developing an agent-based modeling system to model a. coagulation-fibrinolysis-inflammation/immune (CIF) system may include identifying a plurality of agents involved in the CIF system, generating, at a computer system, an identifier and interaction probability value for each of the plurality of agents; the identifier having a value that identifies a type of molecule represented by the agent, and the interaction probability value representing a probability that the agent will react with a neighboring agent, and arranging, at the computer system, the plurality of agents in a computer model, the computer model including a plurality of cells, each cell representing a discrete unit of space, and a set of rules that govern behavior of each of the plurality of agents. The method may also include outputting a result. The outputting may be displaying the result. The probability value may be in a range of about 0.01 to about 1.0. Additionally, the probability value may be in a range of about 0.05 to about 0.5.

Each cell may represent a discrete unit of space in one, two, or three dimensions. The plurality of cells may be arranged in a two-dimensional grid or a three dimensional grid. The computer system may model a blood vessel where the two dimensional grid is in a shape of a rectangle or a three dimensional cylinder. The computer model may simulate blood flow by pulsatile movement of agents through the grid. Each of the plurality of agents may have an identifier with that identifies that agent represents one or more molecular or cellular agents of the CIF system such as s a substrate, an enzyme, a reaction product, an inhibitor, a cofactor, endothelial cell, white blood cells, platelets red blood cells, cell membrane receptors, cytokines, chemokines, biological cells, bacteria, viruses, transcription factors, coagulation factors, second messengers, exogenous anticoagulant factors, exogenous procoagulant factors and a water molecule, fore example.

Varying at least of the plurality of agents may simulate different conditions of the CIF system. The set of rules may specify one or more conditions under which an identifier for an agent should be changed from a first value, representing a first type of molecule, to a second value, representing a second type of molecule, based at least in part on the first value of the identifier and values of identifiers of one or more agents located in neighboring cells.

The method may further include producing a simulated CIF system with the computer model, comparing the simulated CIF system with an empirically-observed CIF system, and identifying the computer model as a valid computer model based on if the simulated system is substantially consistent with the empirically-observed CIF system.

According to a further aspect of the invention, a method of modeling a coagulation-fibrinolysis-inflammation/immune (CIF) system, may include identifying a plurality of agents involved in the CIF system, generating, at a computer system, an identifier and interaction probability value for each of the plurality of agents; the identifier having a value that identifies a type of molecule represented by the agent, and the interaction probability value representing a probability that the agent will react with a neighboring agent, arranging, at the computer system, the plurality of agents in a computer model, the computer model comprising a plurality of cells and a set of rules that govern behavior of each of the plurality of agents, each cell representing a discrete unit of space, and iteratively applying the set of rules to the plurality of agents to simulate a coagulation cascade in the CIF system. Each iterative application of the set of rules to the plurality of agents may represent a discrete unit of time.

The computer model may simulate an initiation, propagation, termination, and lysis of blood clot formation. The computer model may simulate an effect of one or more conditions selected from the group consisting of infection, systemic inflammation, sepsis, ischemia, cardiac arrest, hemorrhage, hemorrhagic shock, tissue trauma, burns, hemodilution, tissue hypoxia, cardiogenic shock, trauma, acidosis, hyperthermia, and hypothermia on the CIF system. The computer model may simulate an effect of the immune/inflammatory response on a coagulation system. The computer model may simulate an effect of the coagulation system on an immune/inflammatory response. The computer model is may be used to identify mediators of the CIF system. The computer model may be used to identify pharmaceutical agents. The computer model may be used to predict single or multiple organ failure when the single or multiple organs are injured.

The computer model may be used to a develop treatment regimens for a patient. The patient may be afflicted with hemophilia, atherosclerosis, cancer, diabetes, lupus, autoimmune disease, acute inflammatory state, a defect in the coagulation system, a defect in the immune/inflammatory response, and a defect in the fibrinolysis system. The treatment regimen may include administering a pharmaceutical agent to the patient. The computer model may be used to predict side effects of pharmaceutical agents.

According to another aspect of the invention an apparatus may include a computer readable medium having encoded thereon a set of instructions executable by a computer system to perform one or more operations, instructions for arranging the plurality of agents in a computer model, the computer model may include a plurality of cells and a set of rules that govern behavior of each of the plurality of agents, where each cell may represent a discrete unit of space; and instructions for iteratively applying the set of rules to the plurality of agents to simulate a coagulation cascade in the CIF system. The set of instructions may include instructions for identifying a plurality of agents involved in a coagulation-fibrinolysis-inflammation/immune (CIF) system, where each agent may represent a molecule in the CIF system and may be defined by an identifier and an interaction probability value, the identifier having a value that identifies a type of molecule represented by the agent, and the interaction probability value may represent a probability that the agent will react with a neighboring agent.

Additional features, advantages, and embodiments of the invention may be set forth or apparent from consideration of the following detailed description, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 is a schematic showing the intrinsic, extrinsic, and common pathways involved in the coagulation cascade.

FIG. 2 is a schematic showing an example of how the coagulation pathway is regulated through the antithrombin-heparin pathway (AT-H pathway). Panel A shows the components of the antithrombin III-heparin pathway. Panel B shows the antithrombin-heparin pathway where the presence of heparin facilitates the binding of antithrombin III to thrombin; heparin is then released from the TAT complex and is available to interact with other thrombin molecules.

FIG. 3 is a schematic showing the inhibition of the coagulation cascade through the tissue factor inhibitory pathway.

FIG. 4 is a schematic illustrating the fibrinolytic system.

FIG. 5 is a flow chart illustrating a method of developing an agent-based simulation system capable of providing a systematic and analytical approach to the CIF system according to principles of the invention.

FIG. 6 is a block diagram of a computer system which can operate the agent-based modeling software of the invention.

FIG. 7 is a schematic representing the cell based model of coagulation used for the cellular based portions of the ABM 2 in specific examples 1-3.

FIG. 8 is a graph generated by using the agent-based model of the invention demonstrating a simulation of the biochemical reactions that make up the coagulation system where the levels of antithrombin and heparin were set at 0.

FIG. 9 is a graph generated by using the agent-based model of the invention demonstrating a simulation of the biochemical reactions that make up the coagulation system where the level of antithrombin was set at 23,000 and the level of heparin was set at 0.

FIG. 10 is a graph generated by using the agent-based model of the invention demonstrating a simulation of the biochemical reactions that make up the coagulation system where the level of antithrombin was set at 23,000 and the level of heparin was set at 10,000.

FIG. 11 is a graph generated by using the agent-based model of the invention demonstrating a simulation of the biochemical reactions that make up the coagulation system where the level of antithrombin was set at 23,000 and the level of heparin was set at 30,000.

FIG. 12 is a graph generated by using the agent-based model of the invention demonstrating a simulation of the biochemical reactions that make up the coagulation system where the level of antithrombin was set at 23,000 and the level of heparin was set at 60,000.

FIG. 13 is a plot generated by using the agent-based model of the invention demonstrating a simulation of prothrombin time and clot formation.

FIG. 14 is a plot generated by the agent-based model of the invention demonstrating a simulation of activated partial thromboplastin time (aPTT) time and clot formation.

FIG. 15 is a plot generated by the agent-based model of the invention demonstrating a simulation of coagulation due to an injury of the epithelia, and fibrinolysis.

FIG. 16 is a plot generated by the agent-based model of the invention demonstrating a simulation of the second element of Virchow's triad. This simulation demonstrates an increase in clot formation size and frequency due to stasis with respect to normal clot background clot formation.

FIG. 17 is a plot generated by the agent-based model of the invention demonstrating a simulation of significant increase in clot formation size and frequency due to hypercoagulability.

FIG. 18 is a plot generated by the agent-based model of invention demonstrating a simulation of DIC due to the exposure of LPS.

FIG. 19 is a plot generated by the agent-based model of the invention demonstrating a simulation of impairment of coagulation of in vivo assays of clot formation due to the activation of hypoperfused, hypotoxic endothelial cells.

FIG. 20 is a plot generated by the agent-based model of the invention demonstrating a simulation of the effects of therapeutic and supra-therapeutic heparin on the aPTT times.

FIG. 21A-D are a plots generated by the agent-based model of the invention demonstrating a simulation of the effects of increasing VIIa-TF concentrations that were used to initiate the formation of IIa in the presence and absence of both TFPI and AT. The circles in the plot indicate 130 pg TF-VIIa, the triangles indicate 30 pg TF-VIIa, and plus symbols indicate 5 pg TF-VIIa. Panel A: no inhibitors present; Panel B: TFPI present; Panel C: AT present; Panel D: TFPI and AT present.

FIG. 22 is a plot generated by the agent-based model of the invention demonstrating a simulation of a prothrombin assay where an excess of TF was introduced into the agent-based model system of the invention. The circles indicate PT and the plus symbols indicate aPTT.

FIG. 23 is a plot generated using the agent-based model of the invention showing aPTT times under pathophysiological conditions. Panel A represents hemophilia B and Panel B represents AT-H binding deficiency.

FIG. 24 is a plot generated using the agent-based model of the invention showing: (Panel A) aPTT times at various heparin concentrations; and (Panel B) PT times at various levels of warfarin therapy.

### DETAILED DESCRIPTION OF THE INVENTION

It is understood that the invention is not limited to the particular methodology, protocols, and reagents, etc., described herein, as these may vary as the skilled artisan will recognize. It is also to be understood that the terminology used herein is used for the purpose of describing particular embodiments only, and is not intended to limit the scope of the invention. It also is be noted that as used herein and in the appended claims, the singular forms “a,” “an,” and “the” include the plural reference unless the context clearly dictates otherwise. Thus, for example, a reference to “a cell” is a reference to one or more cells and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

The invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage devices such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution. The method form of the invention may be practiced by combining one or more machine readable storage devices containing the code according to the invention with appropriate standard computer hardware to execute the code contained therein. An apparatus for practicing the invention could be one or more computers and storage systems containing or having network access to computer program(s) coded in accordance with the invention, and the method steps of the invention could be accomplished by routines, subroutines, or subparts of a computer program product.

Accordingly, provided immediately below is a “Definition” section, where certain terms related to the invention are defined specifically for clarity, but all of the definitions are consistent with how a skilled artisan would understand these terms. Particular methods, devices, and materials are described, although any methods and materials similar or equivalent to those described herein can be used in the practice or testing of the invention. All references referred to herein are incorporated by reference herein in their entirety.

### DEFINITIONS

ABM is agent based modeling

ABMS is agent based modeling and simulation

aPTT is activated partial thromboplastin time

AT is antithrombin

CA is cellular automata

CIF is coagulation-inflammatory/immune-fibrinolysis

CIS is coagulation and inflammatory system

DIC is disseminated intravascular coagulation

FSP is fibrin split products

H is heparin

HMWK is high molecular weight kininogen

INR is international normalized ratio

LPS is lipopolysacchride

ODE is ordinary differential equations

PAI is plasminogen activator inhibitor

PDE is partial differential equations

PT is prothrombin time

PULSE is Post-resuscitative and initial Utility in Life Saving Efforts

ROSC is restoration of spontaneous circulation

TIC is trauma induced coagulopathy

TF is tissue factor

TFPI is tissue factor pathway inhibitor

tPA is tissue plasminogen activator

The term, “simulation,” as used herein generally refers to the solution of a mathematical model by numerical or analytical method, such as the ABM methods of the invention.

The term, “agent,” as used herein generally refers to the molecular and cellular agents such as biological cells (kidney, brain, liver, heart, skin, smooth muscle, and so on), substrates/products, bacteria, viruses, enzymes, cofactors, inhibitors, platelets, red blood cells, endothelial cells, WBC, transcription factors, cytokines, coagulation factors, second messengers, antibodies, intracellular components (e.g., DNA, mRNA, ribosomes, receptors, etc.) and other products of the CIF system.

For example, the agents of the coagulation pathway may include primary clotting factors, such as, prekallikrein (PK), high molecular weight kininogen (HMWK), Factor I (fibrinogen), Factor II (prothrombin), Factor III (tissue factor), Factor IV (calcium), Factor V (proaccelerin, labile factor, (accelerator globulin), Factor VI (accelerin), Factor VII (proconvertin, serum prothrombin conversion accelerator, SPCA), Factor VIII (antihemophiliac factor A, antihemophilic globulin, AHG), Factor IX (Christmas Factor, antihemophilic factor B, plasma thromboplastin component, PTC), Factor X (Stuart-Prower factor), Factor XI (plasma thromboplastin antecedent, PTA), Factor XII (Hageman factor), and Factor XIII (protransglutaminase, fibrin stabilizing factor, FSF, fibrinoligase); additional clotting factors, such as, Protein C, Protein S, thrombomodulin, antithrombin III, and lipoprotein-associated coagulation inhibitor (LACI); factors of the Kallikrein-Kinin System for coagulation, such as, high molecular weight kininogen (HMWK), low molecular weight kininogen (LMWK), tissue plasminogen activator (tPA), nitric oxide (NO), prostacyclin (PGI2), bradykinin, and additional physiologic substances involved in the process may include hematin, skin, fatty acids, sodium urate crystals, protoporphyin, sulfatides, heparins, chondroitin sulfates, articular cartilage, endotoxin, L-homocysteine, and amyloid B protein; factors involved in platelet activation, such as, Phospholipase C γ (PLC γ), Phosphatidylinositol 4, 5 bisphosphate (PIP₂), Inositol triphosphate (IP₃), Diacylglycerol (DAG), Ca2+, Protein kinase C (PKC), Phospholipase A2 (PLA2), phospholipids, Arachidonic acid, Thromboxane A2 (TXA2), Myosin light chain kinase (MLCK), Actin, Interleukins (e.g., IL-1, IL-6), Intracellular adhesion molecule (ICAM1), and Vascular cell adhesion molecule (VCAM1); and thrombin modulators, such as, α2 macroglobulin, heparin cofactor II, and α1 antitrypsin. Cells such as macrophages, neutrophils, lymphocytes, eosinophils, basophils, bacteria, viruses, etc.

The agents of the inflammatory/immune response may include components of the complement system, more specifically, C1 complex, C4, C2, C3-convertase, C3, C5, C5-convertase, C1 inhibitor, decay accelerating factor (DAF), factor B, factor D, membrane attack complex (MAC); components of the kinin system, more specifically, HMWK, LMWK, bradykinin, kallidin, kallikreins, carboxypeptidases, angiotension converting enzyme (ACE, neutral endopeptidase, C1 inhibitor; histamines, P selectin, E selectin, IFN γ, IL-8, leukotriene B4, nitric oxide (NO), prostaglandins, TNFα, IL-1, and integrins.

The agents of the fibrinolysis system may include thrombin-activated fibrinolysis inhibitor (TAFI) (also known as carboxylase U or CPU), α2 antiplasmin, urokinase, tissue plasminogen activator (tPA) and uPA, plasminogen activator-inhibitors type 1 (PAI-1) and type 2 (PAI-2), and plasmin.

The term, “disease state,” as used herein generally refers to a biological state where one or more biological process are related to the cause(s) or clinical signs of the disease. For example, a disease state can be the state of a diseased cell, a diseased organ, or a diseased tissue. Such disease may include, for example, cardiac arrest (CA), congestive heart failure (CHF), atrial fibrillation (AF), cerebrovascular accident (CVA), hemophilia, hypercoagulability of pregnancy, thrombocytopenia, atherosclerosis, deep vein thrombosis (DVT), arterial thrombosis, Peripheral vascular disease (PVD), cancer, hemolytic-uremic syndrome (HUS) and thrombotic thrombocytopenic purpura (TTP), diabetes, autoimmune states, such as Systemic Lupus Erythematosus (SLE or Lupus), acute inflammatory states caused by multi-system trauma and its complications such as trauma induced coagulation (TIC), or infection, other systemic inflammatory states such as sepsis and its complication such as disseminated intravascular coagulation (DIC), low flow states such as cardiac arrest and cardiogenic shock, environmental or iatrogenic induced environmental changes such as hypothermia and hypoxemia, acute inflammatory states caused iatrogenically by, for example, surgery or cardiopulmonary bypass. A diseased state could refer to, for example, a diseased protein such as a defective interferon-gamma receptor or a diseased process, such as defects in cellular activation, cell signaling, or cell mediator production, which may occur in several different organs.

The terms “treatment regimen,” “pharmaceutical regimen,” and “regimen,” may be used interchangeable herein and generally refer to therapeutic actions such as treatment with various pharmaceutical agents, such as anticoagulants (heparin, warfarin, aspirin, GIIb3a inhibitors, plavix, and aPC) and their various derivatives as well as fibrinolytic agents (tpa; clot busting drugs). In addition procoagulants such as OCPs/Estrogen, plasma, platelet, individual factors (VIIa, VIII, and IX) and their various derivatives. The pharmaceutical agents may also include any anti-inflammatory compounds, anti-allergics, glucocorticoids, anti-infective agents, antibiotics, antifungals, antivirals, mucolytics, antiseptics, vasoconstrictors, wound healing agents, local anaesthetics, peptides, and proteins.

The term “treatment,” as used herein, refers to an intervention aimed at the prevention, management, control, or therapy, whether symptomatic, curative, or palliative, of any disease, symptom, condition, or disease state that may affect a patient.

The term “patient,” as used herein, includes individuals who require intervention or manipulation due to a disease state, treatment regimen or experimental design. Furthermore, the term “patient” includes animals and humans.

The term, “action,” as used herein generally refers to the biological activity behavior of an agent, where the agent acts on the environment or another agent. For example, where the agent is a macrophage, the actions of the macrophage include its ability to phagocytize foreign antigens, ability to recruit additional macrophages and other cells and cellular factors (i.e., cytokines, chemokines) to the site of infection, and the ability to manufacture and secrete cytokines, such as interleukins, interferons, tumor necrosis factor, and chemokines Actions for any particular agent may be routinely identified by those of ordinary skill in the art through the use of text books and available scientific literature.

The term, “rule” or “rules,” as used herein, govern the interaction(s) among the agents and their capability to respond to the environment. The rule(s) may be based upon a set of probabilities of occurrences of agent actions, probabilities of occurrences of two or more agents interacting with each other, probabilities of occurrences of agents interacting with the appearance or existence of specified conditions in the system (i.e., concentrations of cofactors, enzymes, substrates, cells, and substrates), and probabilities of occurrences of two or more agents interacting to form a complex of agents. The rules may also define changes in the internal state of a given agent.

The invention generally relates to agent based modeling (ABM) of the coagulation-inflammatory/immune-fibrinolysis (CIF) system. The CIF system may be modeled using a set of rules that defines the biological cells, substrates, enzymes, and products, i.e., “agents,” actions, and interaction of the agents in the CIF system using ABM. A major advantage of the ABMS of the invention, is the ability to monitor each coagulation factor as ‘clotting’ or injury proceeds. This implies that the effect of a large number of factors that influence coagulation (e.g. natural and pharmaceutical anticoagulants, natural and pharmaceutical fibrinolytic agents, and intrinsic and external inflammation mediators) can be simulated readily. The ABMS of the invention will provide information on the overall progress of clotting as well as on individual coagulation factor as a function of time.

Accordingly, the ABM method of the invention may be used to, inter alia, (i) simulate a model of coagulation that successfully reproduces the initiation, propagation, and termination of blood clot formation both in vitro and in vivo; (ii) simulate the effects of systemic inflammation, sepsis, trauma, acidosis, hemodilution, hypothermia, and trauma on the CIF system; (iii) simulate the effects of the immune/inflammatory response on the coagulation system; (iv) simulate the effects of the coagulation system on the immune/inflammatory system; (v) to identify new mediators of the CIF system as well as identify points of CIF system dysfunction; (vi) increase understanding of the proximal and distal effects of the interactions between the highly networked coagulation, immune, and fibrinolysis systems, (vii) identify new diagnostic and therapeutic options such as pharmaceutical agents and pharmaceutical drug treatment regimens, and to develop additional software and algorithms for simulation; (viii) predict the operation of new inter-linked network system(s), if necessary (e.g., the nervous system, based on the inadequate results of the current CIF model); (ix) to develop additional software and algorithms for simulation; (x) predict side effects of therapeutic modalities (pharmaceutical agents); and (xi) to be used as a pathobiology and physiological discovery tool.

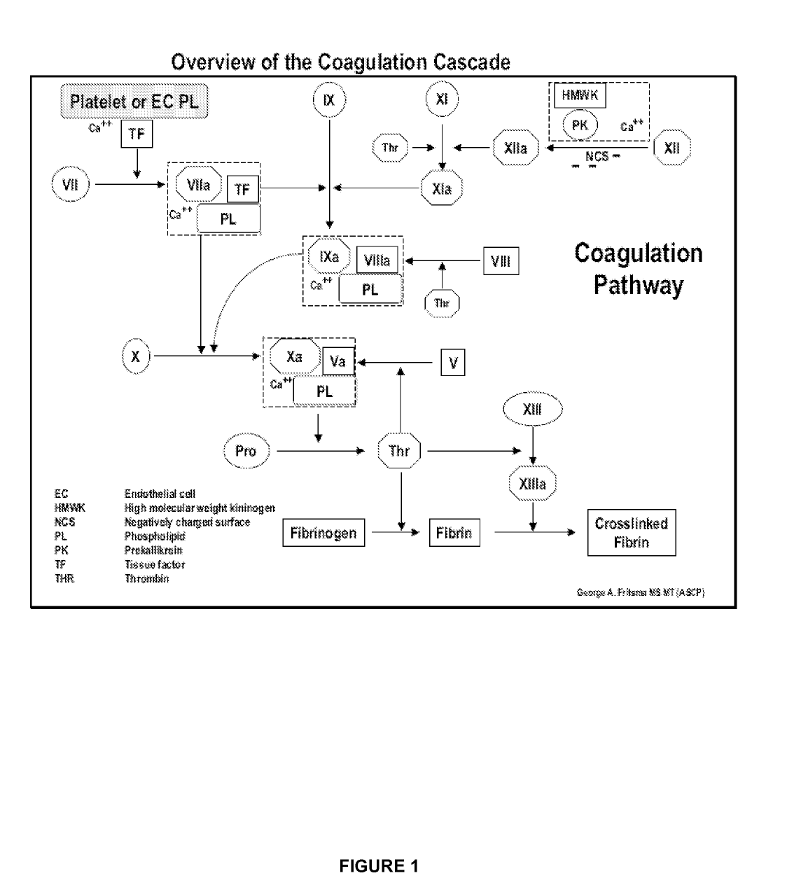

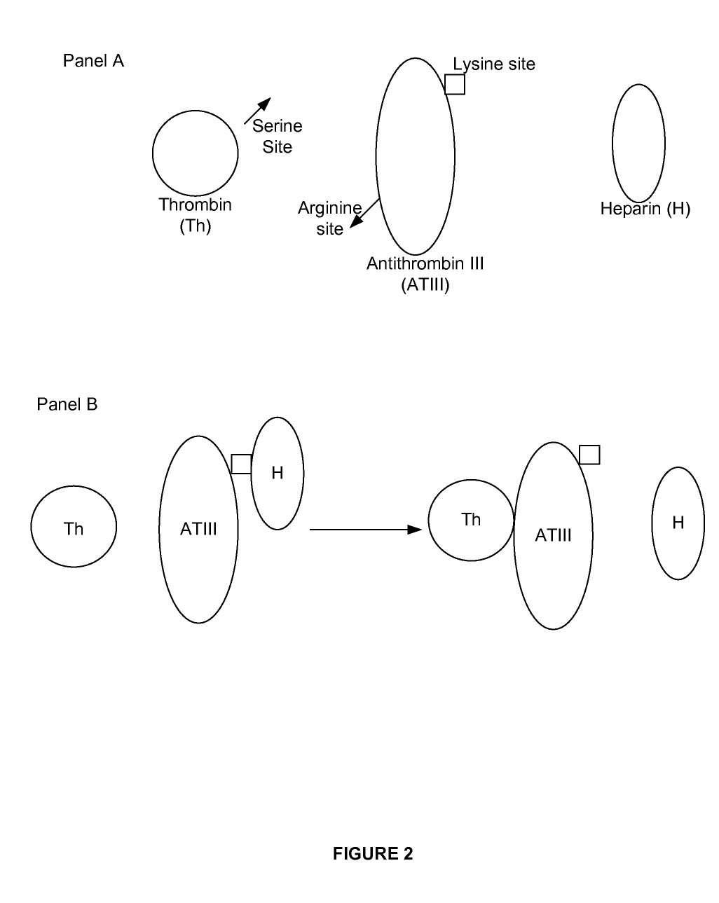

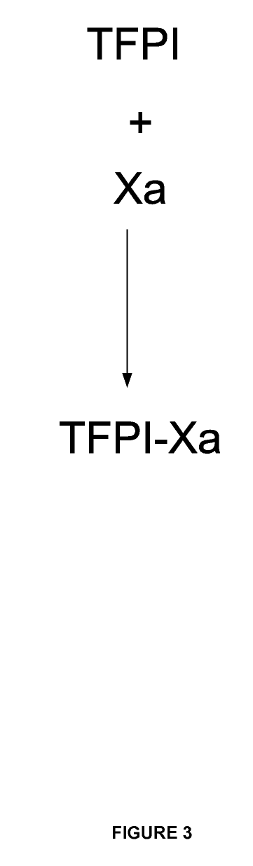

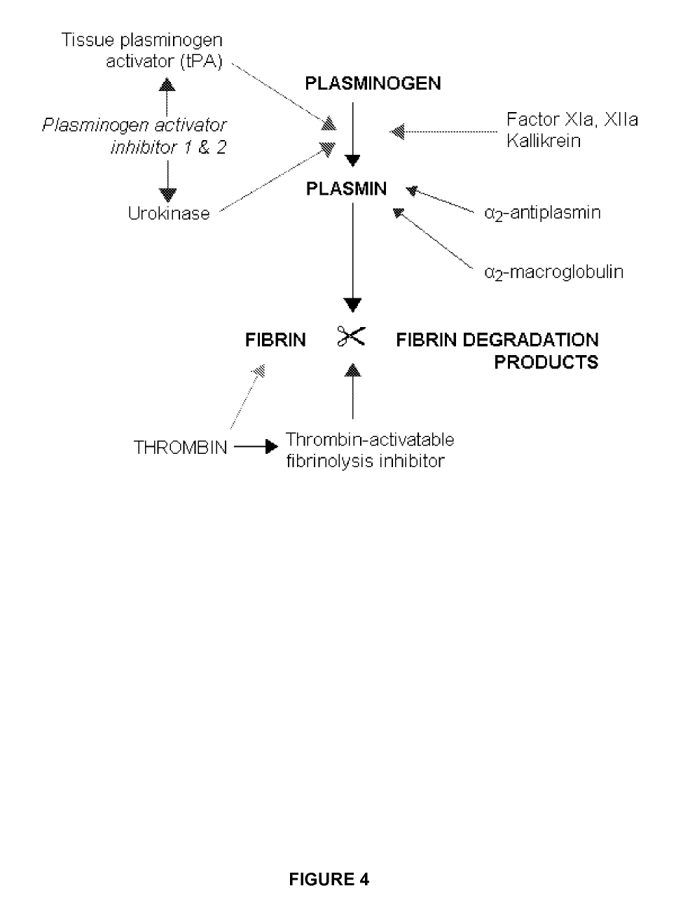

The coagulation system balances the need for localized clot formation, in the event of an injury to the endothelium, against the need to prevent system wide activation. This finely tuned system is composed of an assortment of substrates, enzymes, cofactors, inhibitors, platelets, and endothelial cells all interacting to create a stable clot in order to rapidly obtain hemostasis. Historically, the system is divided into two major pathways, the intrinsic and extrinsic pathways. In this model, activation of Factor VII (i.e., extrinsic pathway, FIG. 1) and activation of Factor XII (i.e., intrinsic pathway, FIG. 1), ultimately converge to form a final common pathway that results in the formation of thrombin. Thrombin then cleaves fibrinogen to form fibrin monomers that polymerize to form a clot. The coagulation cascade is regulated through the antithrombin-heparin pathway (AT-H, FIG. 2), activated protein C, and tissue factor inhibitory pathway (FIG. 3). These regulating systems limit the excessive formation of cross-linked fibrin under hemostatic conditions. In addition, the fibrinolytic system operates to dissolve the pre-formed clot once the underlying damage has been repaired (fibrinolytic system, FIG. 4).

With the complex mechanisms involved in its regulation and its ability to rapidly construct a clot, the blood coagulation system may be viewed as a molecular machine. The multiple feedback loops inherent in the control of the system results in non-linear relationships among the various components. A static diagram cannot adequately characterize this dynamic evolutionary network. Numerous natural feedback and feed-forward loops manipulate the subsystems through nonlinear interactions. In addition, the current level of technology precludes a fundamental understanding of diseases related to imbalances in the coagulation system. Data collection methods are limited to easily measured blood levels of various components or in vitro experiments. These methods cannot adequately characterize the influence of diseases that favor coagulation (e.g. coronary artery disease, disseminated intravascular coagulation, cerebrovascular accidents, and venous thrombosis) nor those that impair coagulation (e.g. hemophilias, thrombocytopenias, and von Willebrand disease).

The human blood coagulation system consists of cellular elements (platelets and endothelial cells) and proteins (the coagulation enzymes/co-factors and a number of anticoagulant proteins). Even under normal physiological conditions, there is a constant generation of small amounts of coagulation proteases; in order to prevent uncontrolled fibrin formation, natural anticoagulant proteins, present in blood and at the vascular endothelial cell surface, balance this process. In addition, an efficient fibrinolytic system assists in limiting the amount of cross-linked fibrin formed under normal conditions. Together, coagulation, anticoagulation and fibrinolysis maintain a delicate physiological balance.

Invariably, appropriate modification in the concentration of one or more proteins involved in these systems will perturb the equilibrium maintained by these pro-coagulation and anti-coagulant forces. Added to the complexity of the coagulation/fibrinolysis systems, work in the past decade indicates strong linkages of these systems with the inflammatory/immune system. These systems are so interdependent in health and disease that the seemingly separate and independent systems operate in fact as fundamentally and coherently linked systems. Thus, the coagulation/fibrinolysis/inflammatory/immune systems can be argued to represent a single system.

Imbalances in either coagulation factors, or coagulation regulators, or inflammatory mediators can be expected to result in abnormal local thrombosis, such as atherothrombosis and venous thrombosis. Likewise, systemic thrombosis, e.g., disseminated intravascular coagulation (DIC), is also a result of an imbalance of the inflammatory/immune system at the organism level. In a similar manner, antithrombotic medications used to treat a variety of illnesses may be expected to affect the inflammatory/immune response of the patient, e.g., activated protein C.

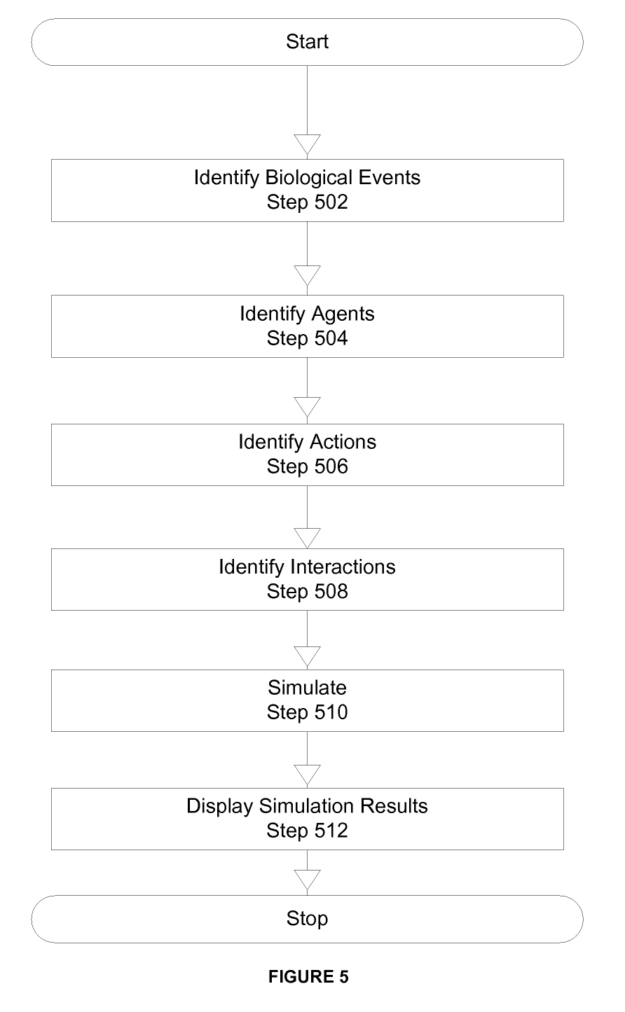

FIG. 5 is a flow chart illustrating a method of developing an agent-based system capable of modeling the CIF system according to principles of the invention. This figure is provided for illustration and is not intended to limit the invention or imply a specific order of steps. As one skilled in the art would appreciate, the order of the steps designated within the flow chart may be varied. In step 502 the biological events associated with the CIF system are identified. At step 504, at least one “agent” involved in the biological events of the CIF system is identified. At step 506, at least one action of the at least one agent of the CIF system is identified. At step 508, at least one interaction of the at least one agent of the CIF agent is identified. At step 510, the biological events, agents, actions of the agents, and interactions of the agents are combined to form a simulation using an agent-based simulation system of the CIF system. In step 512, the data is displayed and analyzed. These steps are described in detail below.

In step 502, at least one biological event associated with the CIF system is identified according to one embodiment of the invention. A biological event indicates an occurrence that takes place during the association between two or more biological entities, such as a injury to the endothelium and clot formation, bacterial infection, sepsis, and the inflammatory/immune response, angioedema, hereditary or acquired, and the activation of the coagulation system, autoimmune disease, such as lupus, and the inflammatory/immune response, pregnancy and the inflammatory/immune response, diabetes and the CIF system, oral contraceptive and clot formation, heart medications and inflammatory/immune response, and any injury to blood vessels that causes damage to the endothelium, such as blunt trauma (e.g., contusion from a car accident, fall, sports injury, etc) or puncture wound (e.g., stabbing) and clot formation and/or immune/inflammatory response. A sequence of events may describe the association, including the events associated with the initiation of the relationship and how it progresses through its “normal” course of development. For example, where the relationship is between the injury to the endothelium and clot formation, the normal course of development includes the recruitment of platelets to the wound site, the stimulation of the coagulation factors, the stimulation of the immune/inflammatory response, and the fibrinolytic system.

In step 504, for each biological event identified, at least one agent associated with the biological event is identified. An agent may be described as the biological entity itself, or any component of the biological entity that possesses a biological activity. Exemplary agents of the CIF system are described above, but briefly may include, cytokines, substrates, cofactors, transcription factors, cells, activated cells, proteins, multi-molecular complexes, inhibitors, platelets, and enzymes present in the CIF system. One skilled in the art appreciates that agents of the CIF system may be readily identified using any source such as journal references, textbooks, encyclopedias, information available on the World Wide Web, patents, oral exchanges, and the like.

In step 506, the actions of the agent are identified, according to another embodiment of the invention. An action may be generally described as the biological activity or behavior of an agent, where the agent acts on the environment and/or with another agent. At least one action for each agent can be identified. An action can also be further characterized and described by its probability of occurrence, and/or the temporal sequence in which it can occur. For example, during the inflammatory/immune response, a macrophage phagocytizes a pathogen, the pathogen is isolated within the macrophage in a phagosome. In the ABM system, the phagosome/pathogen entity can be described as a third agent. This third agent, has components that are not individually described but whose actions and interactions result in the described activity for the third agent. This third agent is composed of a number of components that are not individually described but whose actions and interactions result in the described activity for the third agent is capable of certain actions. For example, the destruction of the pathogen by enzymes and other biomolecules (e.g., hydrogen peroxide) that are produced in, or, that are imported into the phagosome and neutralization of the pathogen such that no further activity by the pathogen occurs. Each one of these actions has a certain probability of occurring and an attendant temporal component.

A probability of occurrence can be determined by the appearance or existence of specified conditions in the system (e.g., concentrations of an enzyme, or enzymes or other biomolecules, that are present in the phagosome) and/or using mathematical formula (e.g., using the Michelis-Menten equation to determine the relative amounts of substrate and product, indicating how much of the substrate is digested by the enzyme) to determine stochastically whether the action will occur and/or interaction probabilities between agents in a given neighborhood. The temporal component of agent action can also be used to specify when certain actions will occur. For instance, when data is available that a certain biological action takes a particular amount of time, this information can be used alone, or in combination with other information, to trigger the agent action so that it occurs in a specific temporal sequence.

In step 508, one or more interactions between the agents may be identified, according to one embodiment of the invention. An interaction is generally referred to as a reaction of response to an agent's action by another agent or the formation of a multi-molecular complex by the interaction of two or more agents with one another. For example, during the coagulation cascade, the activation of factor VII and factor XII result in the formation of multi-molecular complexes, the tenase and prothrombin complexes. In the development of an in silico, ABM, the tenase/prothrombin complex may be described as a third agent.

In one embodiment of the invention, an agent, agent actions and interactions, may be embodied as a software computer program that performs actions and interactions with a set of specified rules. The actions and/or interactions may be represented, for example, as one or more algorithms or mathematical equations that determine the probability of that particular event occurs, and describe that event with an associated temporal constant. The form of the mathematical equations may include for example, partial differential equations, ordinary differential equations, algebraic equations, difference equations, cellular automata, coupled maps, neural networks, Bayesian networks, equations of networks of Boolean or fuzzy logical networks, fuzzy logic, von Neumann modeling, agent based modeling and simulation (ABMS), fuzzy agent based modeling, fuzzy agent based modeling simulation (FABMS) and the like. Von Neumann modeling is currently preferred for certain embodiments as described in further detail below.

In one particular embodiment, the form of the mathematical equations used in the methodology of the invention is ABMS. ABMS provides a powerful alternative to differential equations. The advantages of ABMS include the ability to simulate the non-linear aspects of the CIF system. The agents are able to change state based on their environment. The ABMS of the invention, includes the known inter-dependent and interactive components of the inflammatory/immune system, which impacts coagulation. There interactive components may include molecular and cellular components, i.e., agents, such as platelets and activated forms of platelets, platelet receptors, macrophages, interleukins, lipopolysacchrides, etc. Thus, as an example, ABMS will be able to simulate the process of disseminated intravascular coagulation (DIC), a process that involves both the coagulation and inflammation systems.

A specific advantage of the ABMS is its ability to allow for the addition of newly discovered mediators, which can impact upon both coagulation and inflammation. More importantly, the model has a high probability of exhibiting emergence in which its outputs produce unanticipated results, which can then be biologically confirmed. Such properties are particularly useful in the discovery of diagnostic and therapeutic interventions. Comprehensive modeling of the traditional coagulation cascade linked to inflammatory/immune systems allows virtual experimentation of the effects of local and systemic injury on coagulation. For example, the local vascular inflammatory nature of atherosclerosis in the setting of acute coronary syndrome can be more adequately modeled, which may result in the development of better antithrombotic medications. Similarly, the effect of chronic inflammatory states, such as cancer, diabetes, or autoimmune states, such as lupus, etc., may be studied as they relate to coagulation.

ABMS is a modeling paradigm derived from cellular automata (CA). A CA is a 2-D grid consisting of spaces called “cells.” Each cell is allowed to assume a finite number of states, each determined by a finite set of rules. Every cell is updated each period according to the rules. The rules are a function of the current state of the cell and the state of its neighbors cells. ABMS is an extension of CA in that it has mobile components that can move through the grid.

In ABMS, dynamic models are constructed by discretizing the system, that is time, space, and the internal states of the components are all discretized. The system is advanced tick by tick with the ticks representing some specified amount of time (nanoseconds, milliseconds, hours, or days). In order to discretize space, models are built on a grid of cells. The cells represent some unit of space in one, two, or three dimensions. The cells have a local neighborhood that defines the possibility of interactions between cells. The cells may have two, four, six, eight, ten, twelve, twenty, twenty six, thirty two, or thirty eight local neighbors.

An agent refers to a discrete component with a set of characteristics and rules governing its behaviors and decision-making capability. The discreteness requirement implies that an agent has a boundary. This boundary determines whether something is part of an agent, is not part of an agent, or is a shared characteristic. Rules govern interactions among agents and their capability to respond to the environment. The internal state of the agent is defined as the unique configuration of information in an agent. For example, a cardiac myocyte can be in four possible states (rest, depolarizing, absolute refractory period, and relative refractory period). In the case of a system designed to model biochemical reactions, each agent must be identified with a substrate, enzyme, reaction product, or a water molecule ‘floating’ in a continuum of like cells. In this case, the state determines the component type. Each agent is assigned a discrete probability of joining with agents around it.

For example, an enzymatic reaction can be simulated by changing the state of the agent based on its ability to join with neighboring agents of appropriate attributes leading to the creation of a product. Every agent is bound by the same set of rules for updating its internal state, based on the values of the neighborhood cells as well as the current state of the given agent. Each time the rules are applied to the whole grid a new generation of agents is created.

The system is then iterated over time and analyzed to create the simulation runs, as shown in step 510. In step 510, the rules governing the biological events, agents, agent actions, and agent interaction are combined to simulate an agent based simulation system of the CIF system. The agent base simulation system may be executed by running them on a commercially available agent-based simulation system, such as Netlogo, Repast, Swarm, or by hand written software. The church-turing thesis states that the platform is immaterial to the ability to model.

The agent-based simulation systems of the invention, may be validated by comparing the accuracy of the simulation results to known or generated in vitro or in vivo data.

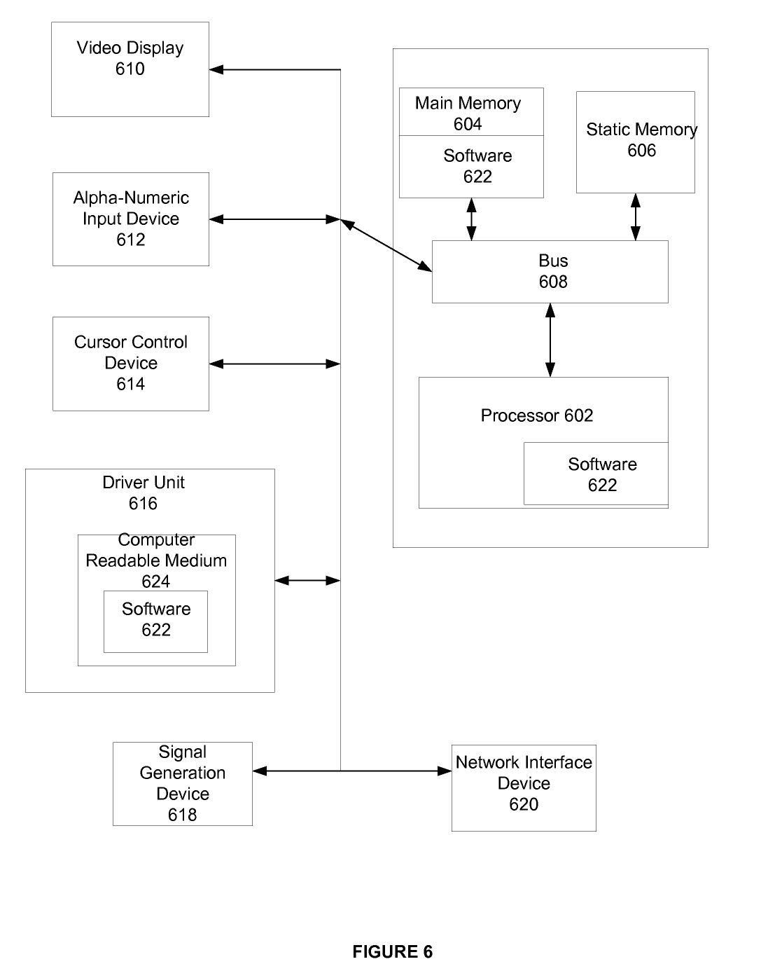

In one embodiment of the invention, a computer system may be used to implement the agent-based model simulations of the invention. FIG. 6 shows a system block diagram of a computer system within which the methods described above can operate via software code, according to an embodiment of the invention. The computer system 600 includes a processor 602, a main memory 604 and a static memory 606, which are coupled by bus 608. The computer system can further include a video display unit 610, such as a liquid crystal display (LCD), cathode ray tube (CRT), or any other type of output on which a use interface can be displayed. The computer system can also include an alpha-numeric input device 612 (e.g., a keyboard), a cursor control device 614 (e.g., a mouse), a disk drive unit 616, a signal generation device 618 and a network interface device medium 620. The disk drive unit 616 includes a computer-readable medium 624 on which software 622 can be stored. The software can also reside, completely or partially, within the main memory 604 and/or within the processor 602. The software 622 can be also transmitted or received via the network interface device 620.

The term “computer readable medium,” as used herein includes any medium which is capable of storing or encoding a sequence of instructions or codes for performing the methods described herein and can include, but not limited to, optical and/or magnetic storage devices and/or disks, and carrier wave signals.

Without further elaboration, it is believed that one skilled in the art using the preceding description can utilize the invention to the fullest extent. The following examples are illustrative only, and not limiting of the disclosure in any way whatsoever.

### EXAMPLES

### Specific Example 1

### Computational Model of Coagulation, Inflammation, and Fibrinolysis

The two ABMS in this example use a two dimensional particle system. The particle model was one in which particles were able to move about and interact on a discrete spatial grid. In this case, the particles of the system were the cells, reactants, enzymes, and products defined in entity Table 1, below.

TABLE 1

| Entity | Description |
|---|---|
| XI | Factor XI Activates XII and IX |
| XIa | Activated factor XI |
| XII | Factor XII (Hagemon factor). Activates XI. |
| XIIa | Activated factor XII |
| XIII | Factor XIII. Crosslinks fibrin monomers to form mature clot. |
| XIIIa | Activated factor XIII |
| XIIIaI | |
| XIIIaE | |
| XIIIaIE | |
| IX | Factor IX (Christmas factor) Activates X. Cofactor of VIII - Forms tenase complex |
| | (Q) |
| IXa | Activated factor IX |
| VIII | Factor VIII. Co-factor of IX - Forms tenase complex (Q) |
| VIIIa | Activated factor VIII |
| VIIIaI | |
| VIIIaE | |
| VIIIaIE | |
| VII | Factor VII. Activates IX and X. |
| f7aTF | Activated factor VII |
| II | Factor II (prothrombin). Activates I, V, VII, XIII |
| IIa | Activated factor II |
| IIaI | |
| IaE | |
| IIaIE | |
| X | Factor X. Activates II. Co-factor of V - forms prothrombinase complex (R) |
| Xa | Activated factor X |
| XaI | |
| XaE | |
| V | Factor V. Co-factor of X - forms prothrombinase complex (R) |
| Va | Activated V |
| VaI | |
| VaE | |
| VaIE | |
| R | prothrombinase complex Va-Xa |
| RI | |
| RE | |
| RIE | |
| Q | tenase complex XIIIa-IXa |
| QI | |
| TF | Tissue Factor. Activates VII |
| F | Fibrinogen - forms clot after conversion to fibrin and polymerization |
| Fm | Fibrin monomer - forms clot after polymerization by XIII |
| FmI | |
| FmE | |
| FmIE | |
| HMWK | high molecular weight kininogen - activates XII |
| Clot | Final product of coagulation cascade |
| ClotI | |
| ClotE | |
| ClotIE | |
| AT | Antithrombin III - inhibits IIa, IXa, and Xa |
| AT-Xa | AT-Xa complex |
| AT-XaI | |
| AT-XaE | |
| AT-IXa | AT-IXa complex |
| AT-IIa | AT-II complex |
| AT-IIaI | |
| AT-IIaE | |
| AT-IIaIE | |
| H | Heparin co-factor of AT |
| AT-H | AT-H Complex |
| TFPI | Tissue Factor Pathway Inibitor |
| TFPI-Xa | TFPI-Xa complex |
| TM | Thrombomodulin |
| TM-IIa | TM-IIa complex |
| PC | Protein C |
| aPC | activated Protein C |
| aPC-V | aPC-V complex |
| aPC-Va | aPC-Va complex |
| aPC-VIIIa | aPC-VIIIa complex |
| PG | Plasminogen |
| uPA | Urokinase Plasminogen Activator |
| tPA | Tissue Plasminogen Activator |
| D-Dimer | D-Dimer |
| PAI-1 | Plasminogen Activator Inhibitor 1 |
| uPA-PAI-1 | uPA-PAI-1 complex |
| tPA-PAI-1 | tPA-PAI-1 complex |
| P | Plasmin |
| AP | Anti-Plasmin |
| P-AP | P-AP complex |
| WBC | White Blood Cell |
| aWBC | Activated WBC |
| EC | Endothelial Cell |
| aPC | Activated Endothelial Cell |
| ET | Endotoxin |
| TNF-a | Tumor Necrosis Factor a |
| Plt | Platelet |
| aPlt | Activated Platelet |

The number of cells used in these simulations was on the order of about 1,000,000 agents with a resultant coagulation factor density of about 12%. Following ‘clotting,’ the number of clot agents (or alternatively clot concentration) increases. These ‘clot’ agents were not removed from the grid to simulate conditions in vivo, where delay of clot removal results in the cessation of bleeding.

In the first ABMS, each cell in this model was either empty or occupied by a substrate, enzyme, or reaction product. The cells were allowed to move freely about the grid. The movement, joining, and breaking were governed by probability rules. The movement parameter determined the extent of movement (0 implies every cell is stationary). The joining parameter determined the extent of a given cell interacting with an adjoining neighbor. The breaking parameter was used to determine the extent of disruption of cells that have joined. This model set the probability of joining=breaking=movement=1. The cells were allowed to interact (join) with its neighbors, but the only meaningful interactions were limited to those in the rule Table 2, below.

TABLE 2

| | | Probability |
|---|---|---|
| # | Reaction | (P) |
| 1 | XII + HMWK → XIIa + HMWK | 0.01 |
| 2 | XI + XIIa → XIa + XIIa | 0.01 |
| 3 | IX + XIa → IXa + XIa | 0.01 |
| 4 | VIII + IIa → VIIIa + IIa | 1.0 |
| 5 | VIII + IIaI → VIIIaI + IIaI | 1.0 |
| 6 | VIII + IIaE → VIIIaE + IIaE | 1.0 |
| 7 | VIII + IIaIE → VIIIaIE + IIaIE | 1.0 |
| 8 | IXa + VIIIa → QI + Empty | 1.0 |
| 9 | X + Q → Xa + Q | 1.0 |
| 10 | X + QI → XaI + QI | 1.0 |
| 11 | V + IIa → Va + IIa | 1.0 |
| 12 | V + IIaI → VaI + IIaI | 1.0 |
| 13 | V + IIaE → VaE + IIaE | 1.0 |
| 14 | V + IIaIE → VaIE + IIaIE | 1.0 |
| 15 | Xa + Va → R + Empty | 1.0 |
| 16 | XaI + Va → RI + Empty | 1.0 |
| 17 | XaE + Va → RE + Empty | 1.0 |
| 18 | Xa + VaI → RI + Empty | 1.0 |
| 19 | XaI + VaI → RI + Empty | 1.0 |
| 20 | XaE + VaI → RIE + Empty | 1.0 |
| 21 | Xa + VaE → RE + Empty | 1.0 |
| 22 | XaE + VaE → RE + Empty | 1.0 |
| 23 | XaI + VaE → RIE + Empty | 1.0 |
| 24 | Xa + VaIE → RIE + Empty | 1.0 |
| 25 | XaE + VaIE → RIE + Empty | 1.0 |
| 26 | XaI + VaIE → RIE + E | 1.0 |
| 27 | II + R → Iia + R | 1.0 |
| 28 | II + RI → IIaI + RI | 1.0 |
| 29 | II + RE → IiaE + RE | 1.0 |
| 30 | II + RIE → IiaIE + RIE | 1.0 |
| 31 | VII + TF → f7aTF + Empty | 0.1 |
| 32 | X + f7aTF → XaE + f7aTF | 1.0 |
| 33 | F + IIa → Fm + IIa | 1.0 |
| 34 | F + IIaI → FmI + IIaI | 1.0 |
| 35 | F + IIaE → FmE + IIaE | 1.0 |
| 36 | F + IIaIE → FmIE + IIaIE | 1.0 |
| 37 | XIII + IIa → XIIIa + IIa | 1.0 |
| 38 | XIII + IIaI → XIIIa + IIaI | 1.0 |
| 39 | XIII + IIaE → XIIIaE + IIaE | 1.0 |
| 40 | XIII + IIaIE → XIIIaIE + IIaIE | 1.0 |
| 41 | Fm + XIIIa → Clot + XIIIa | 1.0 |
| 42 | Fm + XIIIaI → Clot + XIIIaI | 1.0 |
| 43 | Fm + XIIIaE → ClotE + XIIIaE | 1.0 |
| 44 | Fm + XIIIaIE → ClotIE + XIIIaIE | 1.0 |
| 45 | FmI + XIIIa → ClotI + XIIIa | 1.0 |
| 46 | FmI + XIIIaI → ClotI + XIIIaI | 1.0 |
| 47 | FmI + XIIIaE → ClotIE + XIIIaE | 1.0 |
| 48 | FmI + XIIIaIE → ClotIE + XIIIaIE | 1.0 |
| 49 | FmE + XIIIa → ClotE + XIIIa | 1.0 |
| 50 | FmE + XIIIaI → ClotIE + XIIIaI | 1.0 |
| 51 | FmE + XIIIaE → ClotE + XIIIaE | 1.0 |
| 52 | FmE + XIIIaIE → ClotIE + XIIIaIE | 1.0 |
| 53 | FmIE + XIIIa → ClotIE + XIIIa | 1.0 |
| 54 | FmIE + XIIIaI → ClotIE + XIIIaI | 1.0 |
| 55 | FmIE + XIIIaE → ClotIE + XIIIaE | 1.0 |
| 56 | FmIE + XIIIaIE → ClotIE + XIIIaIE | 1.0 |
| 57 | AT + XaI → AT-XaI + Empty | 0.1 |
| 58 | AT + XaE → AT-XaE + Empty | 0.1 |
| 59 | AT + IXa → AT-IXa + Empty | 0.1 |
| 60 | AT + IIa → AT-IIa + Empty | 0.1 |
| 61 | AT + IIaI → AT-IIaI + Empty | 0.1 |
| 62 | AT + IIaE → AT-IIaE + Empty | 0.1 |
| 63 | AT + IIaIE → AT-IIaIE + Empty | 0.1 |
| 64 | AT + H → AT-H + Empty | 1.0 |
| 65 | AT-H + XaI → AT-XaI + H | 1.0 |
| 66 | AT-H + XaE → AT-XaE + H | 1.0 |
| 67 | AT-H + IXa → AT-IXa + H | 1.0 |
| 68 | AT-H + IIa → AT-Iia + H | 1.0 |
| 69 | AT-H + IIaI → AT-IiaI + H | 1.0 |
| 70 | AT-H + IIaE → AT-IIaE + H | 1.0 |
| 71 | AT-H + IIaIE → AT-IIaIE + H | 1.0 |
| 72 | TFPI + Xa → TFPI-Xa | 1.0 |
| 73 | TM + IIa → TM-IIa | 1.0 |
| 74 | TM-IIa + PC → aPC + TM-IIa | 1.0 |
| 75 | aPC + V → aPC-V | 1.0 |
| 76 | aPC + Va → aPC-Va | 1.0 |
| 77 | aPC + VIIIa → aPC-VIIIa | 1.0 |
| 78 | PG + uPA → P | 1.0 |
| 79 | PG + tPA → P | 1.0 |
| 80 | P + Clot → D-Dimer | 1.0 |
| 81 | uPA + PAI-1 → uPA-PAI-1 | 1.0 |
| 82 | tPA + PAI-1 → tPA-PAI-1 | 1.0 |
| 83 | P + AP → AP-P | 1.0 |
| 84 | ET + WBC → TNFa | 1.0 |
| 85 | ET + EC → aEC | 1.0 |
| 86 | EC + TNF a → aEC | 1.0 |

ABMS modeling requires the assignment of probability of conversion to each molecular interaction event. As these are all enzymatic activities with affinities in the nanomolar range and a high turnover frequency, a probability of conversion value of 1.0 (P=1.0) was assigned to most reactions (the exceptions are listed in the third column of the rule Table 2, above). These probabilities may be modified based on kinetic information available in the literature. The initial configuration was random with a predefined number of cells assigned to each substrate and enzyme.

Prothrombinase and tenase complexes are formed through a combination of three factors each in vivo. For example, prothrombinase complex is formed by a combination of prothrombin, factor Xa and factor Va, while the intrinsic tenase complex is formed when factors VIIIa and IXa combine with factor X. These three body complexes were not directly simulated in ABMS as in vivo, these complexes must arise through sequential combination of two molecules. Thus, a sequential two-body collision approach was used to generate each complex. The three-body complexes prothrombinase and intrinsic tenase were assigned the names R and Q, respectively.

The second ABM was divided into two systems. The first system represented the in vitro environment. In this case, the grid was in the shape of a rectangle allowing the particles to interact and bounce off the edge of the grid. There were no cells in the system as the in vitro tests are run on acellular plasma. The second system was designed to model a blood vessel in vivo. In this case, the grid was in the shape of a rectangle. The sides of the rectangle represent endothelial cells and allow particles to interact with the endothelial cells or bounce off the walls. The ends are empty and allow the loss and introduction of particles. Blood flow was simulated by pulsatile movement of the particles through the system. It is a user defined variable that can simulate conditions such as high flow through arteries and slow flow through veins (including periods of blood stasis).

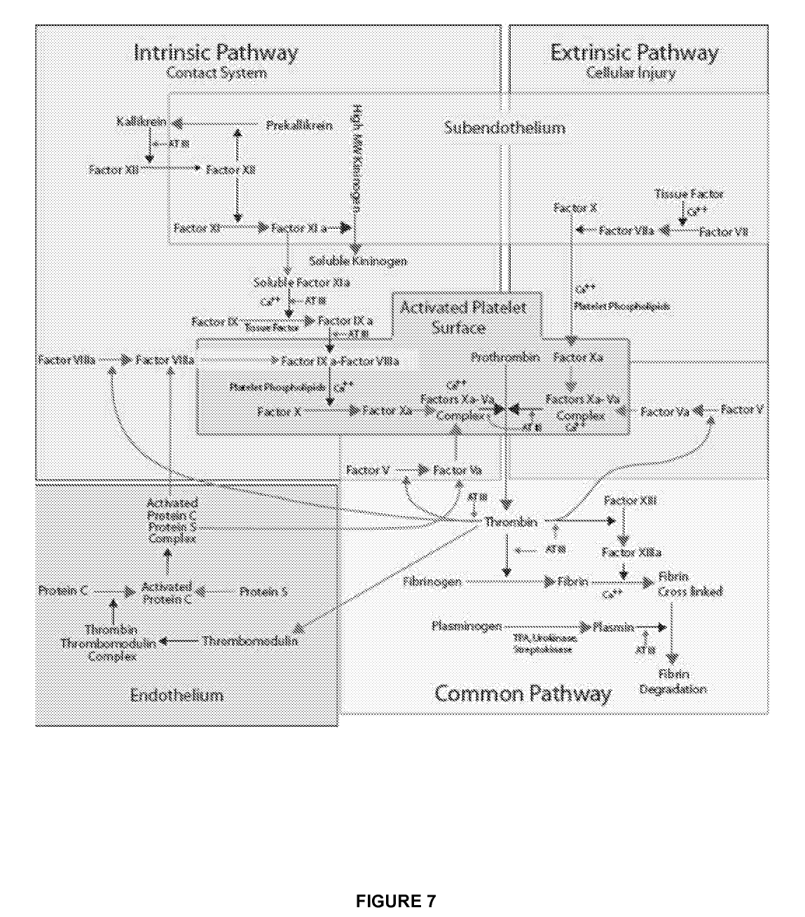

Modeling of the system was performed under conditions that simulated the physiologic concentrations of each soluble factor and membrane-bound tissue factor involved in the cascade, which were derived from literature reports. Thus, factors II, V, VII, VIII, IX, X, XI, XII and XIII were assigned initial values of 14000, 200, 100, 3, 900, 1700, 300, 4000 and 900 agents, respectively, which correspond to concentrations of 1.4, 0.02, 0.01, 0.0003, 0.09, 0.17, 0.03, 0.4 and 0.09 μM in human blood under normal physiological conditions. High molecular weight kininogen (HMWK) and tissue factor (TF), two clot initiating factors of the intrinsic and extrinsic pathways, were assigned 9000 and 1 agent, respectively, which corresponds to their blood concentrations of 0.9 and 0.0001 μM. The cell based system of coagulation for ABM 2 is reflected in FIG. 7.

### ABM 1 Results:

In this model, each agent must be identified with a substrate, enzyme, reaction product, or a water molecule ‘floating’ in a continuum of like cells. Each cell in this model was either empty or occupied by a substrate, enzyme, or reaction product. The cells are allowed to move freely about the grid. The movement, joining, and breaking are governed by probability rules shown in the rules Table 2, above. The movement parameter determined the extent of movement (0 implies every cell is stationary). The joining parameter determined the extent of a given cell interacting with an adjoining neighbor. The breaking parameter was used to determine the extent of disruption of cells that have joined. This model sets the probability of joining=breaking=movement=1. The cells were allowed to interact (join) with its neighbors, but the only meaningful interactions were limited to those in the rule Table 2, above.

This model is acellular and was designed to simulate the biochemical reactions that make up the coagulation system. The interactions between components of the system mimic the spatial interactions between molecules. That is, 2 components could only interact if they were neighbors and components were unable to move through each other rather they could only travel through unoccupied space. The neighborhood of each cell was defined as a von Neumann neighborhood composed of the four directly adjoining cells (north, south, east, and west).

A total of five simulations were created in this example. The first five simulations differ by varying the concentration of Antithrombin III (AT) and heparin (H). All the simulations utilize the same rules and they have the same initial concentration of cells (with the exception of AT and H). The average time for each run is about 40 hours with 2.4 GHz CPU.

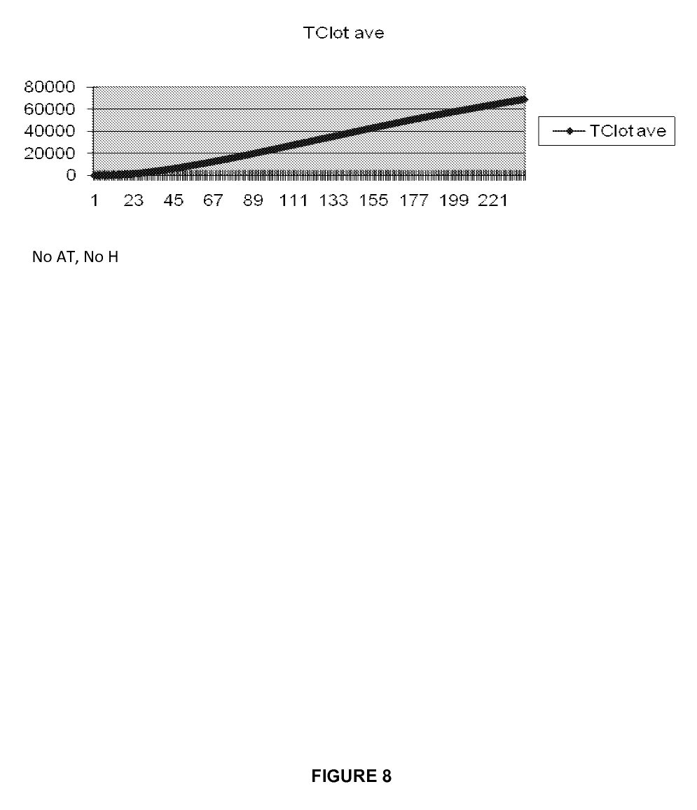

The first simulation FIG. 8 sets the AT and H levels at 0. The grid is 1,000,000 cells. The initial R=Q is set at 10. The lack of inhibition to the coagulation cascade leads to a sigmoidal curve. The graph has the initiation, propagation, and termination of clotting.

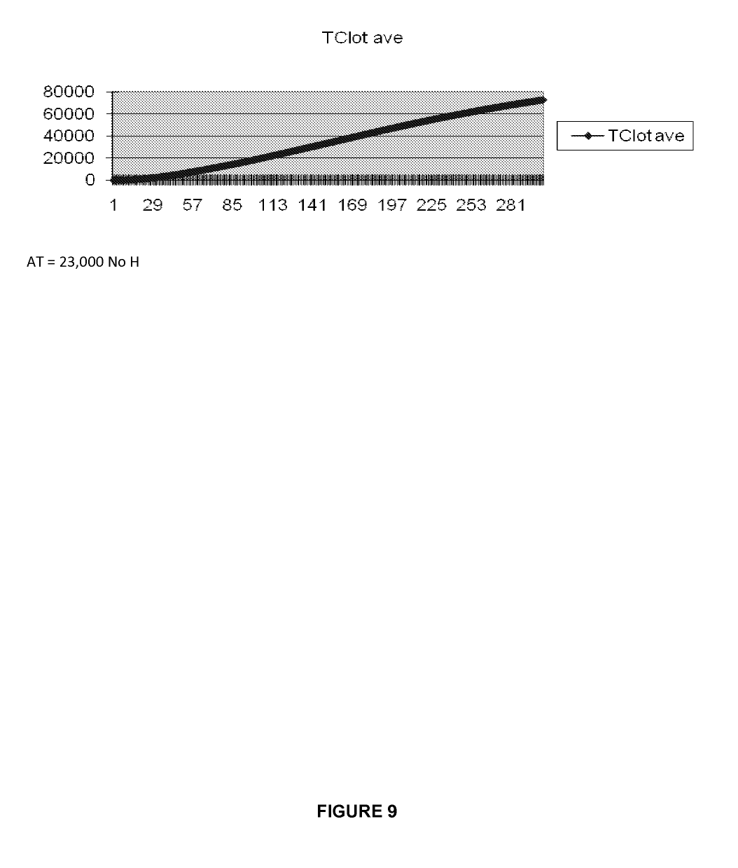

The second simulation (FIG. 9) sets the AT level at 23,000 and H levels at 0. The grid is 1,230,000 cells. The initial R=Q is set at 10. At 40,000 iterations, the clot level was 30,140. The AT serves as an inhibitor of coagulation leading to a longer initiation phase. At 80,000 iterations, the clot level was 360,832.

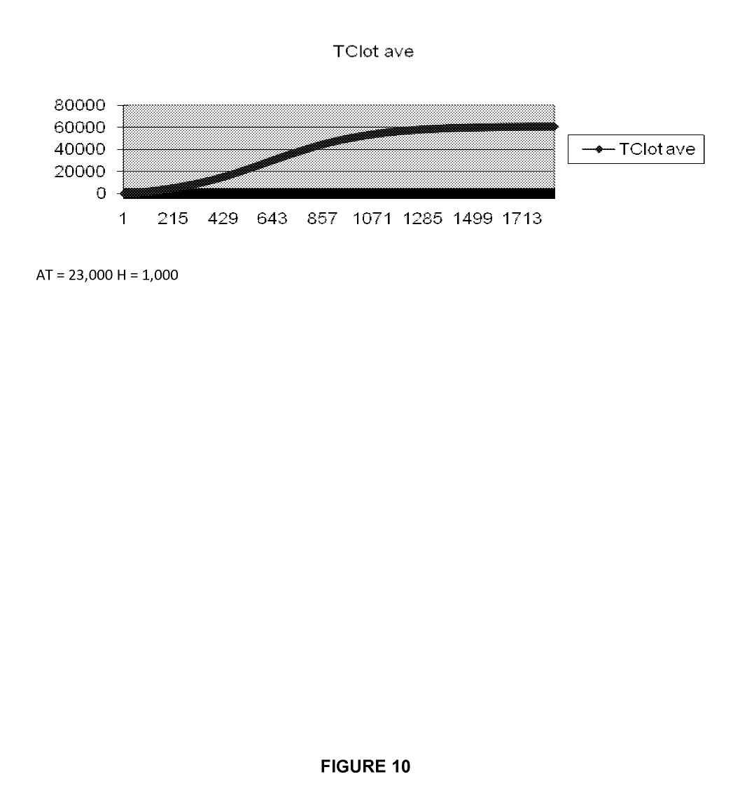

The third simulation (FIG. 10) sets the AT level at 23,000 and H levels at 10,000. The grid is 1,230,000 cells. The initial R=Q is set at 10. At 40,000 iterations, the clot level was 13,007. At 80,000 iterations, the clot level was 248,165. The addition of low levels of H to AT has a significant inhibitory effect.

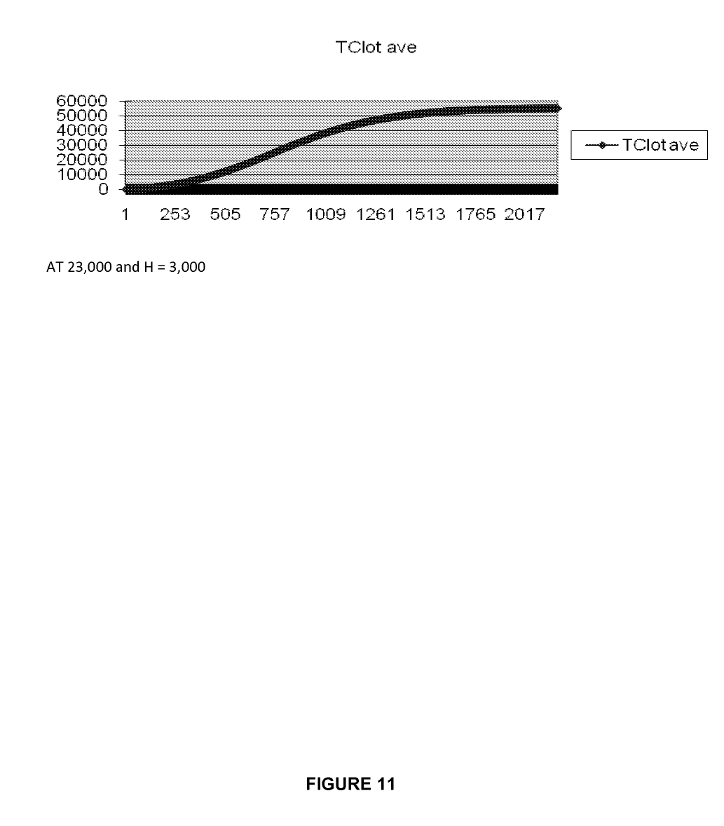

The fourth simulation (FIG. 11) sets the AT level at 23,000 and H levels at 30,000. The grid is 1,230,000 cells. The initial R=Q is set at 10. At 40,000 iterations, the clot level was 10,116. At 80,000 iterations, the clot level was 172,397.

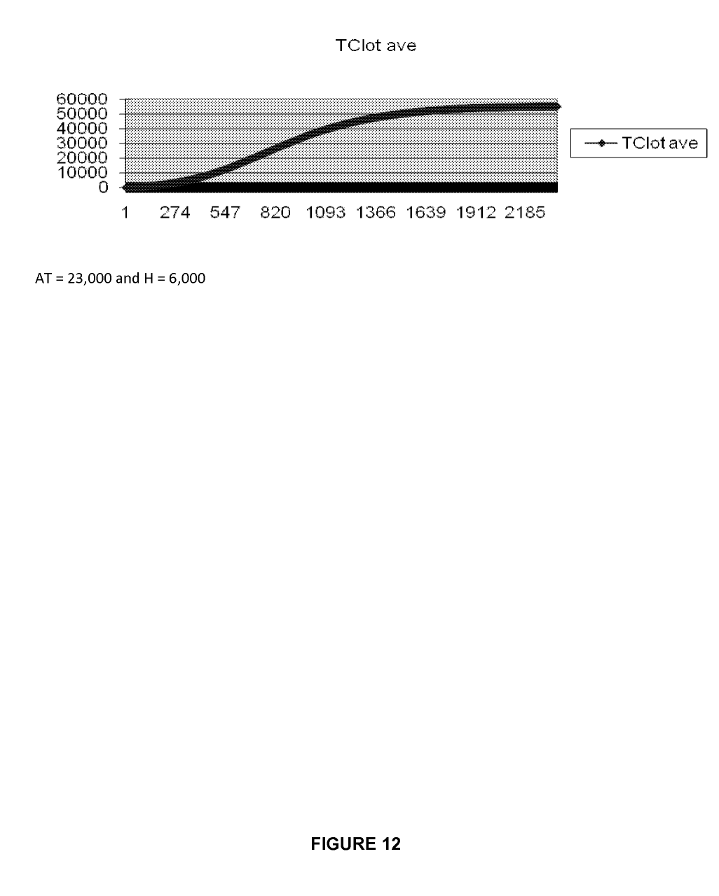

The fifth simulation (FIG. 12) sets the AT level at 23,000 and H levels at 60,000. The grid is 1,230,000 cells. The initial R=Q is set at 10. At 40,000 iterations, the clot level was 7,712. At 80,000 iterations, the clot level was 84,148.

### ABM 2 Results:

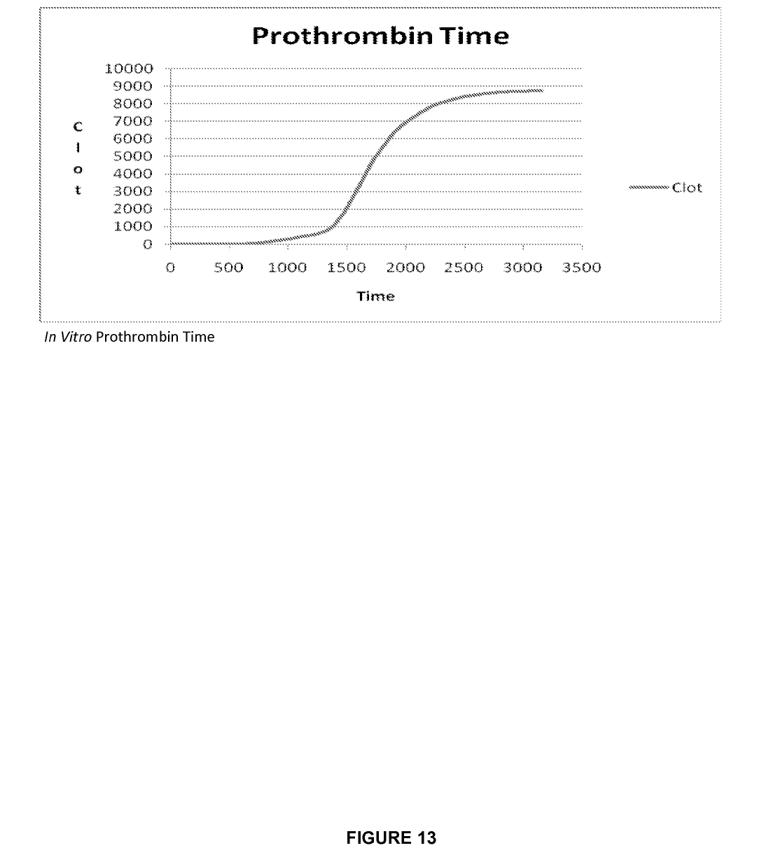

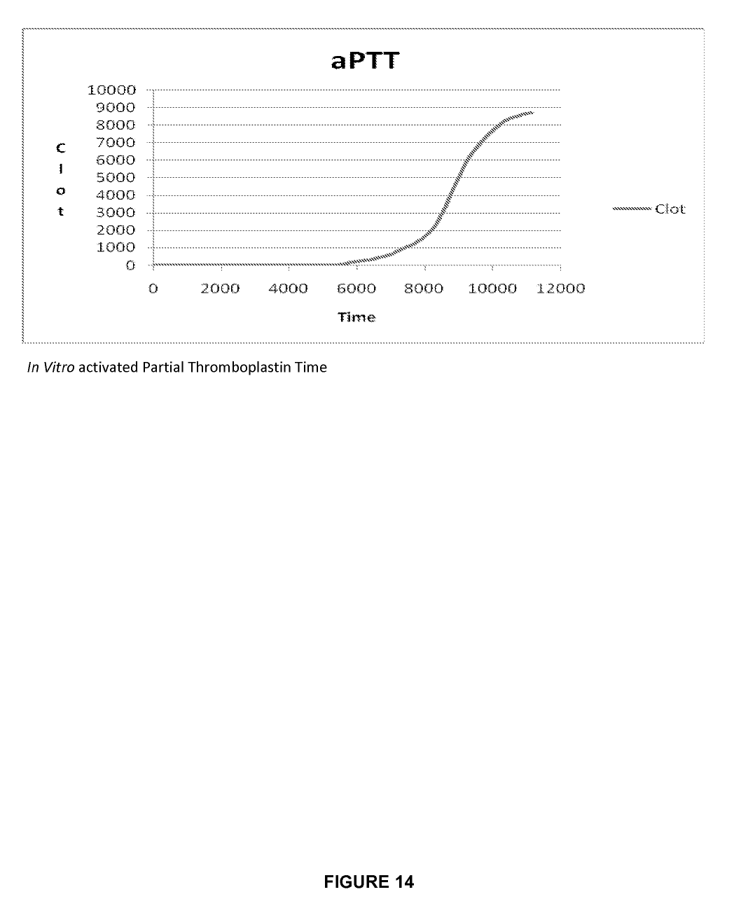

A total of 20 ABMS were created for this example. The neighborhood of each agent in this model is all agents in the same cell. The first set of simulations is the in vitro assays of coagulation. The test was run on plasma, so there are no cell agents in the simulation (platelets, endothelial cells, or WBC). The first simulation (FIG. 13) was designed to simulate the prothrombin time (PT). In order to initiate coagulation, excess TF was introduced into the system otherwise the initial values were the same as listed above. The assay shows three phases of coagulation: initiation, propagation, and termination. The second simulation (FIG. 14) was designed to simulate the activated Partial Thromboplastin Time (aPTT). In order to initiate coagulation, the extrinsic pathway was activated, similar to introducing kaolin in the in vitro assays. The results were similar to the first simulation, but the initiation phase took more time as compared to the PT resulting in a longer time until clot formation. The results were consistent with in vitro assays in which the aPTT takes approximately 1.5 times as long as the PT.

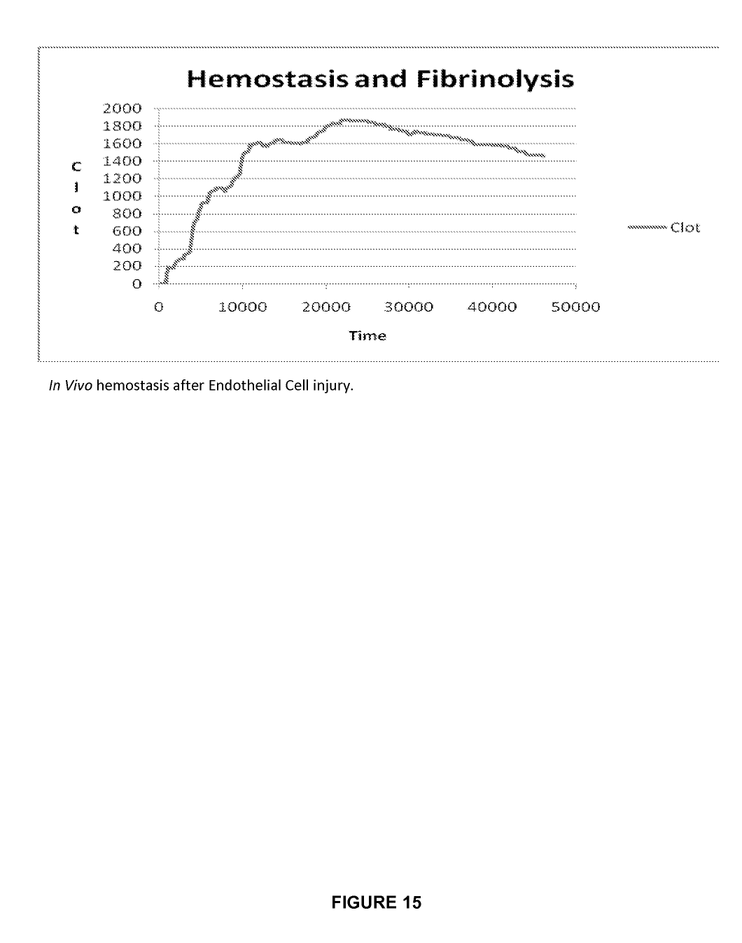

The next set of simulations introduced a blood vessel as well as both platelets and WBC. The blood vessel is composed of endothelial cells. The first simulation (FIG. 15) of this set demonstrated coagulation, due to an injury to the epithelia, and fibrinolysis. Prior to initiating the simulation, a defect in the endothelial lining was created. The defect expressed both TF and collagen. Primary hemostasis was initiated immediately as a result of platelets that encounter the area aggregate and express receptors to bind activated platelets. The platelets also degranulate ADP and Factor V. The platelets provided a phospholipid surface on which the prothrombinase and tenase complexes could form. Concurrent with primary hemostasis, secondary hemostasis begins with the activation of the coagulation system. Free Factor VII binds to the exposed TF resulting in an active Factor VIIa complex the serves to initiate clotting. The activation of thrombin served as a feedforward mechanism that resulted in the activation of factor VIII and IX that serves to activate factor X. Factor XIII crosslinked the fibrin polymers and produced a mature clot that plasmin can lyse at a very slow rate. The PC, TFPI, and AT systems prevented the systemic activation of the coagulation system thereby ensuring clot formation is limited to the site of endothelial damage. Once the damaged endothelial wall was clotted, the coagulation system turned off as the PC, TFPI, and AT systems served to shut down the coagulation system and the system returned to baseline. At that time, the fibrinolytic system slowly dissolved the clot.

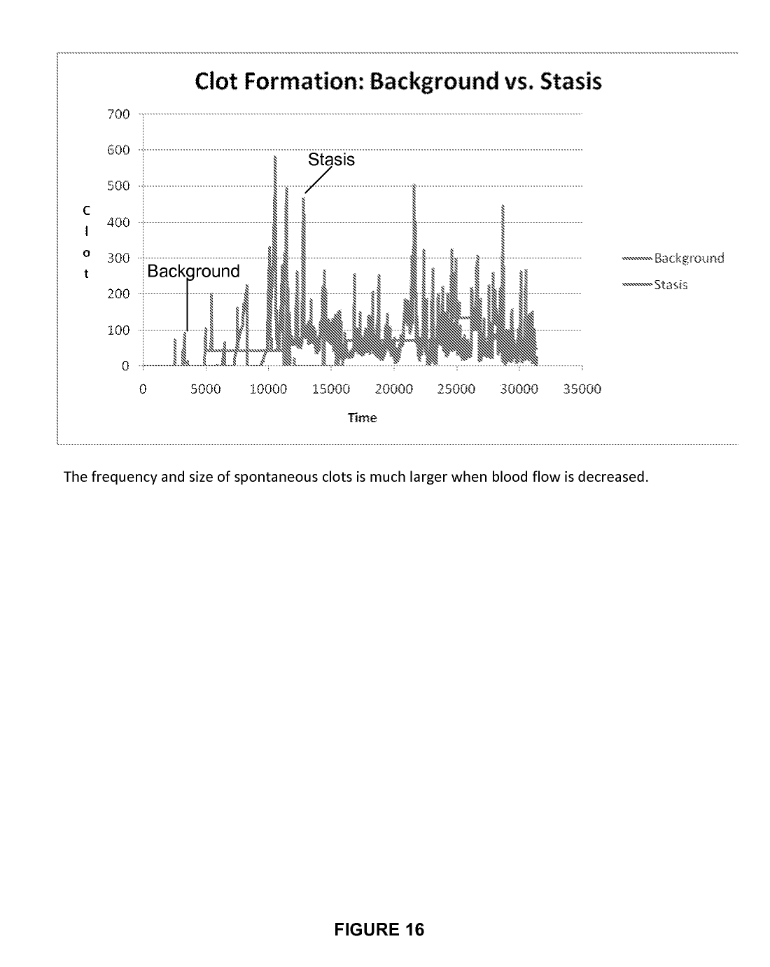

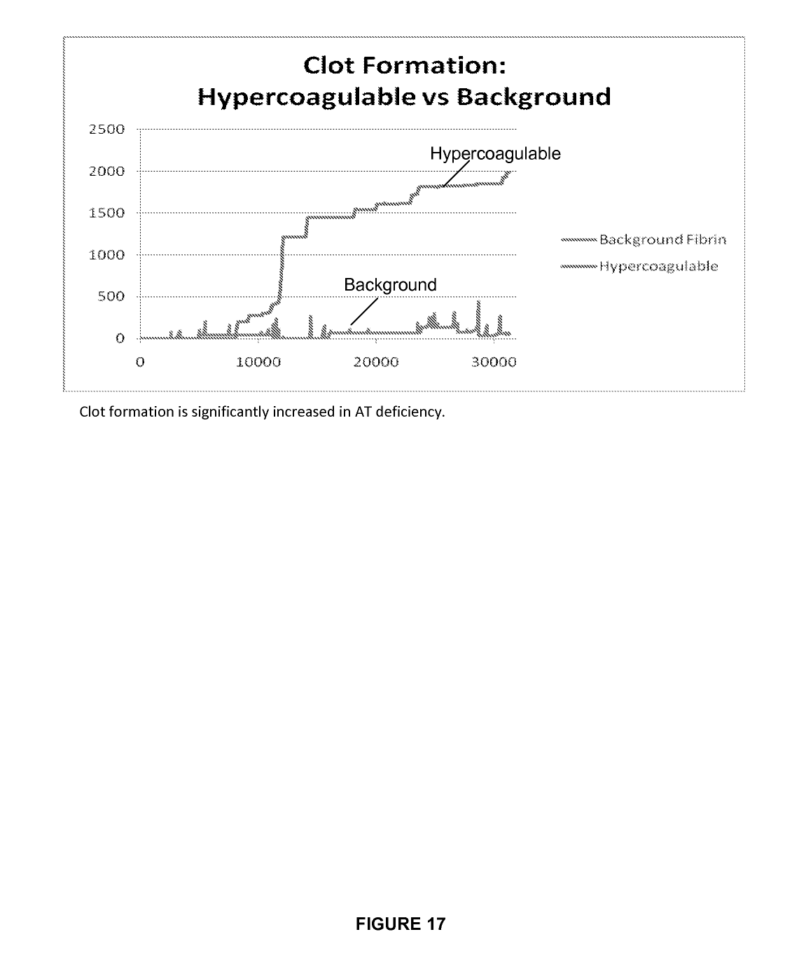

In order to validate the local model of coagulation, Virchow's triad was tested to determine if it applied to the ABM system. One of the important clinical aspects of the in vivo coagulation system is the formation of pathologic venous thrombosis. The risk factors associated with the formation of DVT are described in Virchow's triad: (i) Alterations in normal blood flow (stasis); (ii) Injuries to the vascular endothelium; and (iii) Alterations in the constitution of blood (hypercoagulability). The second element of Virchow's triad has been successfully demonstrated in ABM model in FIG. 16. Blood stasis was simulated by decreasing the flow of particles through the system by 90%. Even under normal physiological conditions, there was a constant generation of small amounts of coagulation proteases, but a perturbation of Virchow's triad led to increase in the size and frequency of clot formation. FIG. 16 demonstrates the increase in clot formation size and frequency due to stasis with respect to the normal background clot formation. Not only do more clots form of larger size, but they also persist for longer periods of time. Therefore, the probability of forming a pathologic venous thromboembolism is significantly increased. Hypercoagulability was simulated using a deficiency in the antithrombin levels. FIG. 17 demonstrates the significant increase in clot formation size and frequency due to hypercoagulability.

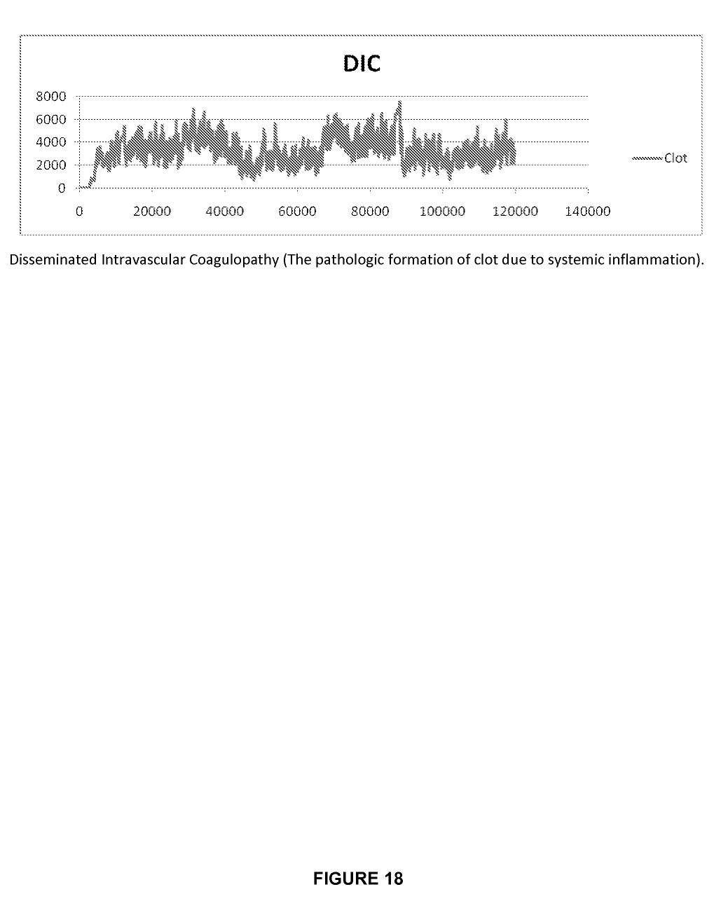

The last set of simulations was designed to analyze the effects of systemic variables on the coagulation system. The fourth simulation represents the formation of DIC due to the activation of the inflammatory system. The initiating event may be due to an infectious process, burns, chemical exposure, obstetric etiology, cancer, or trauma. Each process results in the activation of the inflammatory system with a subsequent activation of the coagulation system. The activation of the coagulation system leads to the formation of microvasculature clot formation and a consumptive coagulopathy that subsequently impairs the process of hemostasis. FIG. 18 demonstrates the simulation of sepsis and DIC due to the exposure of LPS. A state of equilibrium between clot formation and clot lysis arises and, with time, consumes the anticoagulant and fibrinolytic factors. Table 3, below, demonstrates the alteration in the plasma levels of AT, Fibrinogen, platelet, and Fibrin Split Products (FSP).

TABLE 3

| Time (h) | AT (mcMol) | Fibrinogen (mcM) | Platelet (×10\hat{ }9) | FSP |
|---|---|---|---|---|
| 0 | 4.50 | 88.20 | 300 | 0.0 |
| 1 | 4.37 | 83.74 | 291 | 0.3 |
| 2 | 4.14 | 79.54 | 288 | 1.2 |
| 3 | 3.88 | 75.84 | 274 | 1.9 |
| 4 | 3.65 | 74.91 | 271 | 2.7 |
| 5 | 3.41 | 70.79 | 255 | 3.5 |
| 6 | 3.17 | 66.73 | 242 | 4.5 |
| 7 | 2.96 | 66.21 | 240 | 5.2 |
| 8 | 2.74 | 64.29 | 227 | 6.0 |
| 9 | 2.52 | 61.75 | 213 | 6.8 |
| 10 | 2.32 | 61.75 | 213 | 7.3 |
| 11 | 2.04 | 30.02 | 41 | 27.4 |
| 12 | 1.80 | 29.63 | 39 | 33.5 |
| 13 | 1.62 | 29.63 | 39 | 34.4 |
| 14 | 1.46 | 24.14 | 25 | 35.2 |
| 15 | 1.24 | 23.76 | 20 | 36.7 |
| 16 | 1.07 | 22.06 | 11 | 37.5 |

As can be expected, the levels of AT, Fibrinogen and platelets decrease as they were consumed by the systemic activation of the coagulation system, and the levels of FSP continue to increase as the clot is continually dissolved by the fibrinolytic system. The current model was limited to a single small blood vessel which prevented a significant decrease in the systemic levels of fibrinogen and AT. Therefore, a scaling factor was introduced into the model that assumes the process is happening in parallel in multiple blood vessels. As the model is scaled up, it is anticipated that the systemic levels of fibrinogen and AT will fall and the scaling factor will be removed.

Another set of variables that affect the coagulation system include temperature, pH, and coagulation factor concentration. By changing each of these variables, the rate at which the coagulation reactions proceed is markedly altered. These variables have been included in the ABM model in order to simulate the effects of alterations in homeostasis on the coagulation system that can result from illnesses such as trauma, infections, hypothermia, hypoxia, toxic exposure, etc. The effects of temperature, pH, and coagulation factor dilution are synergistic as can be demonstrated in Table 4, below.

TABLE 4

| Sample | PT (ms) | INR |
|---|---|---|
| Normal | 12000 | 1 |
| Acidosis | 18200 | 1.51 |
| Hypothermia | 18800 | 1.56 |
| Acidosis + Hypothermia | 26600 | 2.21 |
| Dilution | 20100 | 2.51 |
| Dilution + Acidosis + Hypothermia | 34800 | 2.90 |
| Severe Dilution | 71460 | 5.96 |
| Severe Dilution + Acidosis + | 93200 | 7.76 |
| Hypothermia | | |
| Coumadin Sub-Therapeutic | 22600 | 1.88 |
| Coumadin Therapeutic | 32600 | 2.72 |
| Coumadin Supra-Therapeutic | 90600 | 7.55 |
| Coumadin Toxic | >120000 | >10 |

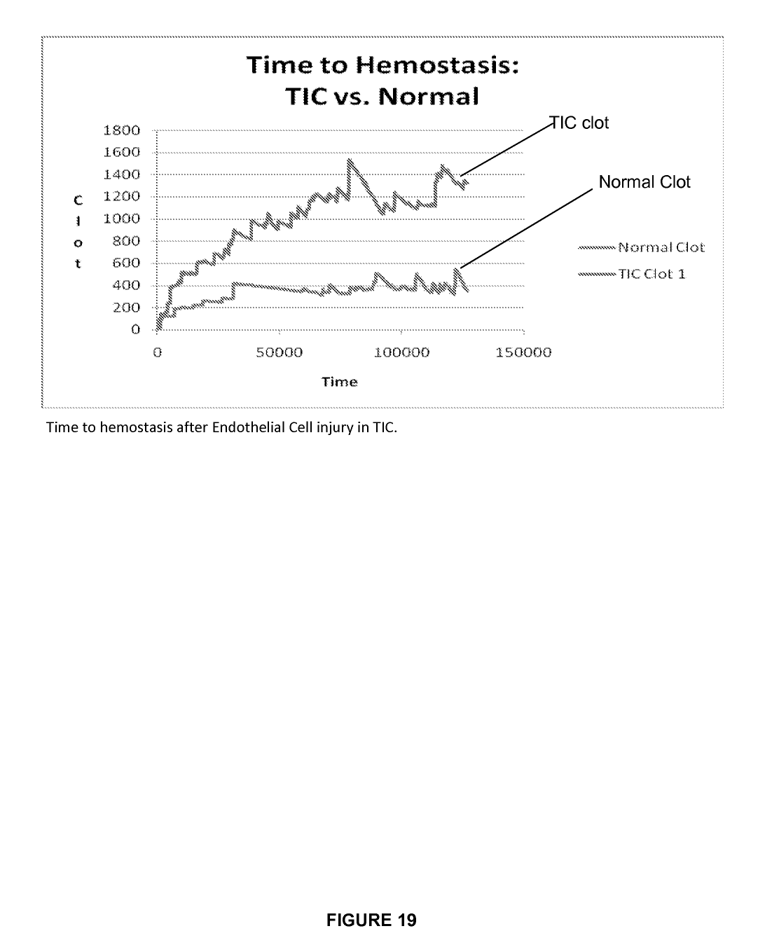

Another important application is trauma induced coagulopathy (TIC). In addition to the effects of acidosis, hypothermia, and coagulation factor dilution, hypovolemia and hypoxia are hypothesized to activate endothelial cells. A state of relative anti-coagulation and hyperfibrinolysis follows independent of fluid resuscitation, temperature, and pH. The activation of endothelial cells due to hypoxia results in the increased expression of TM, TFPI, and tPA with a concomitant decrease in PAI. The resultant diversion of thrombin to the activation of PC combined with increased in TFPI and the binding of thrombin by TM creates a state of anti-coagulation. The increased levels of tPA combined with decreases in PAI results in a state of hyperfibrinolysis that serves to dissolve clot that is able to form in the anti-coagulation environment. The model was able to demonstrate the impairment of coagulation of in vivo assays of clot formation due to the activation of hypoperfused, hypoxic endothelial cells (FIG. 19).

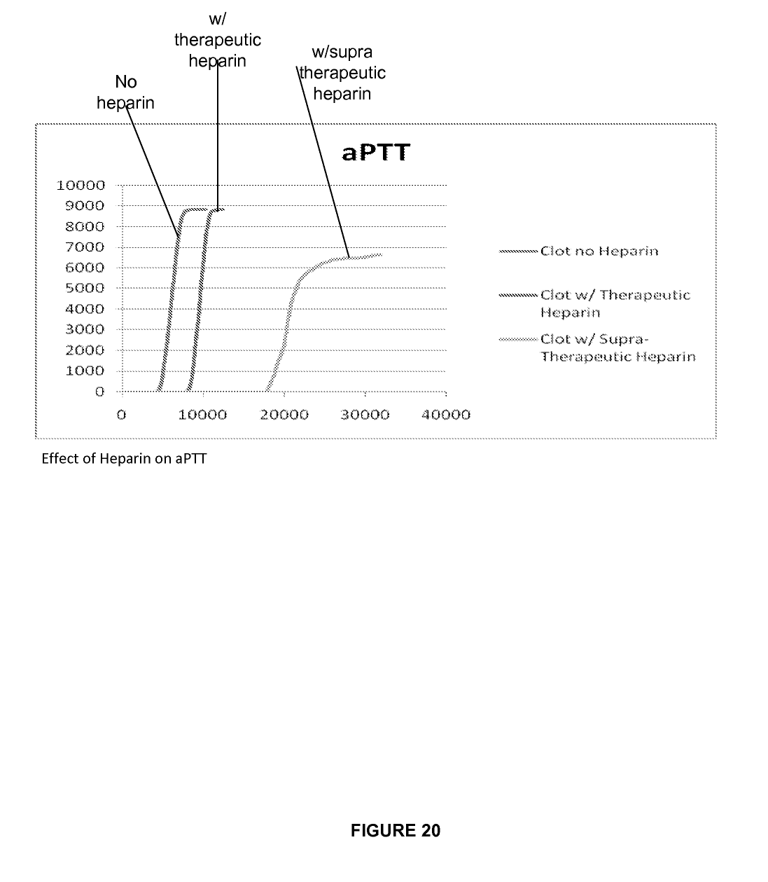

The last important systemic modulators of coagulation and inflammation include pharmaceutical agents. Drugs such as heparin, warfarin, recombinant aPC, recombinant VIIa, and the like can easily be simulated using the model. FIG. 20, demonstrates the effects of therapeutic and supra-therapeutic heparin on the aPTT times. Similarly, Table 4, above, demonstrates the effects of therapeutic and supra-therapeutic warfarin levels on PT times.

### Specific Example 2

### A Computational Model of In Vivo Trauma Induced Coagulopathy

The PULSE initiative identified prevention of diffuse coagulopathies to be a priority in resuscitation science. Trauma Induced Coagulation (TIC) is a significant complication of trauma involving the complex nonlinear interplay of the coagulation and inflammation system (CIS). Its complexity poses significant challenges for systematic clinical study. Since modeling using computational approaches may be valuable adjunct, a model of TIC using a 2-D Agent Based Model (ABM) was developed.

For this example, a 2-D particle system was developed in which particles move and interact on a discrete spatial grid composed of ‘cells’. The particles of the system were cells (endothelial, WBC, platelets), reactants, enzymes, and reaction products. The number of ‘cells’ used in the simulations was 1,000,000 with a coagulation factor density of 16%. The particles' actions were determined by a set of rules derived from coagulation kinetics and cell behaviors. The system was designed to model a blood vessel in vivo including blood flow. The model was perturbed by alterations in systemic variables (temperature, pH, coagulation factor concentration, oxygenation).

The effects of temperature, pH, and coagulation factor dilution were synergistic on the model resulting in increased INR values ranging from about 1.5 to about 7.76, as shown in Table 5, below.

TABLE 5

| Sample | PT (ms) | INR |
|---|---|---|
| Normal | 12000 | 1 |
| Acidosis | 18200 | 1.51 |
| Hypothermia | 18800 | 1.56 |
| Acidosis + Hypothermia | 26600 | 2.21 |
| Dilution | 20100 | 2.51 |
| Dilution + Acidosis + Hypothermia | 34800 | 2.90 |
| Severe Dilution | 71460 | 5.96 |
| Severe Dilution + Acidosis + Hypothermia | 93200 | 7.76 |

Additionally a state of anti-coagulation and hyperfibrinolysis existed independent of temperature and pH. Endothelial cell activation from hypovolemia resulted in the increased expression of TM, TFPI, and tPA with a concomitant decrease in PAI. This resulted in a state of anticoagulation from the diversion of thrombin to the activation of PC (by binding to thrombin) combined with increased TFPI. Increased levels of tPA combined with decreases in PAI resulted in a state of hyperfibrinolysis that dissolved any clot formed in the anti-coagulation environment.

The simulation in this example indicated that the effects of trauma on the CIS can be readily simulated. The ABM successfully modeled TIC as seen in vivo due to endothelial cell activation from hypoperfusion as supported by the literature.

### Specific Example 3

### Computational Modeling of the Effect of Cardiac Arrest on the Coagulation System

The PULSE initiative identified prevention of diffuse coagulopathies to be a priority in resuscitation science. Coagulopathy is a potential significant complication of cardiac arrest that involves the complex nonlinear interplay of the coagulation and inflammation system (CIS). This complexity has made it difficult to study in an integrative fashion at the microvessel level in cardiac arrest. Accordingly, a 2-D Agent Based Model (ABM) was developed in order to better understand the CIS in cardiac arrest.

In this example, the ABM utilized a 2-D particle system. Particles move and interact on a discrete spatial grid. The particles of the system were the cells, reactants, enzymes, and reaction products. The system was designed to model a blood vessel in vivo. The grid was in the shape of a rectangle. The sides of the rectangle represent endothelial cells; particles were capable of interacting with the endothelial cells. In a steady state, blood flow was suddenly discontinued for 20 minutes followed by return of spontaneous circulation (ROSC) for another 20 minutes. The levels of circulating coagulation factors and their products and function were continually monitored.

After 20 minutes of no flow, a state of hypercoagulability, impaired fibrinolysis, and systemic microthrombi formation was observed, which is consistent with post-arrest clinical studies in the literature. Endothelial cell response to hypoxia resulted in elevated levels of TAT and fibrin monomers, which is also consistent with activation of the coagulation system. Concomitant lack of D-dimer and FSPs demonstrated the decreased expression of TM, TFPI, and tPA. Following ROSC, the activation of the anticoagulation system and proinflammatory mediators resulted in a disruption of the equilibrium between the coagulation, anti-coagulation, fibrinolytic and inflammatory systems consistent with a clinical state of low grade DIC. This was also consistent with the literature.

Accordingly, the ABM model in this example simulated the effects of cardiac arrest on the CIS, which may be useful for studying arrest induced CIS changes as well as what effects various interventions such as hypothermia may have. The data obtained may be used to target mediator levels for verification as well as to design studies that may modulate the CIS to improve outcomes.

### Specific Example 4

### Computational Model of Coagulation and Fibrinolysis

The ABMS in this example used a two dimensional particle system. The particle model is one in which particles are able to move about and interact on a discrete spatial grid. In this case, the particles of the system are the reactants, enzymes, and products defined in the entity table (Table 6, below).

TABLE 6

| Entity | Description |
|---|---|
| XI | Factor XI Activates XII and IX |
| XIa | Activated factor XI |
| XII | Factor XII (Hagemon factor). Activates XI. |
| XIIa | Activated factor XII |
| XIII | Factor XIII. Crosslinks fibrin polymers to form mature clot. |
| XIIIa | Activated factor XIII |
| IX | Factor IX (Christmas factor) Activates X. Cofactor of VIII - Forms tenase complex |
| IXa | Activated factor IX |
| VIII | Factor VIII. Co-factor of IX - Forms tenase complex |
| VIIIa | Activated factor VIII |
| VII | Factor VII. Activates IX and X. |
| VIIa | Activated factor VII |
| II | Factor II (prothrombin). Activates F, V, VII, XIII |
| IIa | Activated factor II |
| X | Factor X. Activates II. Co-factor of V - forms prothrombinase complex (R) |
| Xa | Activated factor X |
| V | Factor V. Co-factor of X - forms prothrombinase complex (R) |
| Va | Activated V |
| Va-Xa | prothrombinase complex |
| XIIIa-IXa | tenase complex |
| TF | Tissue Factor. Activates VII |
| TF-VIIa | TF-VIIa complex |
| F | Fibrinogen - (Factor I) forms clot after conversion to fibrin and polymerization |
| Fm | Fibrin monomer - forms clot after spontaneous polymerization |
| HMWK | high molecular weight kininogen - co-factor for activation of XI, XII, and PK |
| XI | Factor XI |
| XIa | Activated Factor XI |
| XII | Factor XII |
| XIIa | Activated Factor XII |
| PK | Prekallikrein |
| K | Kallikrein |
| Clot | Final product of coagulation cascade |
| AT | Antithrombin III - inhibits VIIa-TF, IIa, IXa, and Xa |
| AT-Xa | AT-Xa complex |
| AT-IXa | AT-IXa complex |
| AT-IIa | AT-II complex |
| H | Heparin - co-factor of AT |
| AT-H | AT-H Complex |
| Ka | Kaolin activates the contact portion of the intrinsic system |
| TFPI | Tissue Factor Pathway Inibitor - inhibits VIIa-TF, Xa |
| TFPI-Xa | TFPI-Xa complex |
| PG | Plasminogen |
| uPA | Urokinase Plasminogen Activator |
| tPA | Tissue Plasminogen Activator |
| D-Dimer | D-Dimer |
| PAI-1 | Plasminogen Activator Inhibitor 1 |
| uPA-PAI-1 | uPA-PAI-1 complex |
| tPA-PAI-1 | tPA-PAI-1 complex |
| P | Plasmin |
| AP | Anti-Plasmin |
| P-AP | P-AP complex |

The spatial grid was defined as a 2 dimensional grid where the agent's location was defined as its x and y coordinates. Each unique coordinate pair (x, y) was defined as a cell. The number of CA cells used in these simulations is on the order of 20,000. Each time step of the simulation represented 0.01 seconds.

Each cell in this model was either empty or occupied by substrate, enzyme, or reaction products. The cells were allowed to move freely about the grid. The movement, joining, and breaking were governed by probability rules. The movement parameter determined the extent of movement (0 implies every cell is stationary). The joining parameter determined the extent of a given cell interacting with an adjoining neighbor. The breaking parameter was used to determine the extent of disruption of cells that have joined. In this model, the probability was set so joining=breaking=movement=1. The cells were allowed to interact (join) with its neighbors, but the only meaningful interactions were limited to those in the rule table (Table 7, below). The neighborhood of each agent in this model was defined as all agents located in the same cell. After each time step the agents moved in a random manner to one of the adjacent cells.

TABLE 7

| Rule # | Reaction | Pathway |
|---|---|---|
| 1 | XII + Ka + HMWK → XIIa + Ka + HMWK | Intrinsic |
| 2 | XII + XIIa → XIIa + XIIa | Intrinsic |
| 3 | PK + XIIa + HMWK → K + XIIa + HMWK | Intrinsic |
| 4 | XII + K + HMWK → XIIa + K + HMWK | Intrinsic |
| 5 | XI + XIIa + HMWK → XIa + XIIa + | Intrinsic |
| | HMWK | |
| 6 | XII + XIa → XIIa + XIa | Intrinsic |
| 7 | IX + XIa → IXa + XIa | Intrinsic |
| 8 | X + IXa → Xa + IXa | Intrinsic |
| 9 | XI + IIa → XIa + IIa | Intrinsic |
| 10 | VIIIa + IXa → VIIIa-IXa | Intrinsic |
| 11 | VIIIa + IXa → VIIIa-IXa | Intrinsic |
| 12 | VIIIa-IXa + X → VIIIa-IXa-X | Intrinsic |
| 13 | VIIIa-IXa + X → VIIIa-IXa-X | Intrinsic |
| 14 | VIIIa-IXa-X → VIIIa-IXa-Xa | Intrinsic |
| 15 | VIIIa → VIIIa1 + VIIIa2 | Intrinsic |
| 16 | VIIIa → VIIIa1 + VIIIa2 | Intrinsic |
| 17 | VIIIa-IXa → VIIIa1 + VIIIa2 + IXa | Intrinsic |
| 18 | VII + TF → VII-TF | Extrinsic |
| 19 | VII + TF → VII-TF | Extrinsic |
| | VIIa + TF → VIIa-TF | Extrinsic |
| 21 | VIIa + TF→ VIIa-TF | Extrinsic |
| 22 | VIIa-TF + VII → VIIa-TF + VIIa | Extrinsic |
| 23 | Xa + VII → Xa + VIIa | Extrinsic |
| 24 | IIa + VII → IIa + VIIa | Extrinsic |
| 25 | VIIa-TF + X → VIIa-TF-X | Extrinsic |
| 26 | VIIa-TF + X → VIIa-TF-X | Extrinsic |
| 27 | VIIa-TF-X → VIIa-TF + Xa | Extrinsic |
| 28 | VIIa-TF + Xa →VIIa-TF-Xa | Extrinsic |
| 29 | VIIa-TF + Xa →VIIa-TF-Xa | Extrinsic |
| | VIIa-TF + IX →VIIa-TF-IX | Extrinsic |
| 31 | VIIa-TF + IX →VIIa-TF-IX | Extrinsic |
| 32 | VIIa-TF-IX $$ VIIa-TF + IXa | Extrinsic |
| 33 | Xa + II →Xa + IIa | Common |
| 34 | IIa + VIII →IIa + VIIIa | Common |
| 35 | F + IIa →Fm + IIa | Common |
| 36 | Fm + Fm →Clot | Common |
| 37 | Clot + XIIIa →X-Linked Clot | Common |
| 38 | IIa + V →IIa + Va | Common |
| 39 | Xa + Va →Xa-Va | Common |
| 40 | Xa + Va →Xa-Va | Common |
| 41 | Xa-Va + II →Xa-Va-II | Common |
| 42 | Xa-Va + II →Xa-Va-II | Common |
| 43 | Xa-Va-II →Xa-Va + IIa | Common |
| 44 | XIII + IIa → XIIIa | Common |
| 45 | Xa + TFPI → Xa-TFPI | TFPI |
| 46 | Xa + TFPI→ Xa-TFPI | TFPI |
| 47 | TF-VIIa-Xa + TFPI → TF-VIIa-Xa-TFPI | TFPI |
| 48 | TF-VIIa-Xa + TFPI → TF-VIIa-Xa-TFPI | TFPI |
| 49 | TF-VIIa Xa-TFPI → TF-VIIa-Xa-TFPI | TFPI |
| 50 | AT + Xa →AT-Xa | AT |
| 51 | AT + TF-VIIa →AT-TF-VIIa | AT |
| 52 | AT + IXa →AT-IXa | AT |
| 53 | AT + IIa →AT-IIa | AT |
| 54 | AT + XI →AT-XI | AT |
| 55 | AT + XII →AT-XII | AT |
| 56 | AT + K →AT-K | AT |
| 57 | AT + H →AT-H | AT |
| 58 | AT-H + Xa →AT-Xa + H | AT |
| 59 | AT-H + TF-VIIa →AT-TF-VIIa + H | AT |
| 60 | AT-H + IXa →AT-IXa + H | AT |
| 61 | AT-H + IIa →AT-IIa + H | AT |
| 62 | AT-H + XI →AT-XI + H | AT |
| 63 | AT-H + XII →AT-XII + H | AT |
| 64 | AT-H + K →AT-K + H | AT |
| 65 | PG + uPA →P | Fibrinolysis |
| 66 | PG + tPA →P | Fibrinolysis |
| 67 | P + Clot →D-Dimer + D-Dimer | Fibrinolysis |
| 68 | uPA + PAI-1 →uPA-PAI-1 | Fibrinolysis |
| 69 | tPA + PAI-1 →tPA-PAI-1 | Fibrinolysis |
| 70 | P + AP →AP-P | Fibrinolysis |

ABMS modeling required the assignment of probability of conversion to each molecular interaction event defined in the rule Table 7, above. As these are all enzymatic activities with affinities in the nanomolar range and a high turnover frequency, a probability of conversion value related to the kinetics of the reactions was assigned. The initial configuration was random with a predefined number of agents assigned to each substrate and enzyme that determined the concentration of the agent.

Both prothrombinase and tenase complexes were formed through a combination of three factors in vivo. For example, prothrombinase complex was formed by a combination of prothrombin, factor Xa and factor Va, while the intrinsic tenase complex was formed when factors VIIIa and IXa combine with factor X. These three body complexes were not directly simulated in ABMS, as in vivo, these complexes must arise through sequential combination of two molecules. Thus, a sequential two-body collision approach was used to generate each complex.

The ABMS was designed to represents the in vitro environment. In this case, the spatial grid was in the shape of a rectangle allowing the particles to interact and bounce off the edge of the grid. There were no platelets, RBC, or WBC in the system as the in vitro tests were run on acellular plasma. The reactions and rate constants represented by the rule Table 7, above were representative of experimentally observed rates under saturating phospholipid and calcium concentrations.

An instantiation of the ABMS was implemented using the Netlogo platform in order to perform the simulations. The user determined the subset of reactants, the subset of reactions, the subset of coagulation factors, rate constants, initial factor concentrations, and termination conditions for each simulation. The concentration of every coagulation factor was output every 100 time steps (1 virtual second). The output of each simulation was stored in a comma separated file. All simulations were carried out on a Pentium based desktop personal computer running Microsoft Windows XP. Up to 3 simulations were run in parallel at a time. Each simulation took between 1-72 hours depending on the initial and stop conditions.

Unless otherwise stated, modeling of the system was performed under conditions that simulated the mean physiologic concentrations of each soluble factor (Table 8, below) involved in the cascade, which were derived from literature reports in human blood under normal physiological conditions.

TABLE 8

| | Initial | |
|---|---|---|
| | Concentration | # of |
| Agent | (microM) | Agents |
| II | 1.4 | 140,000 |
| V | 0.02 | 2,000 |
| VII | 0.01 | 1,000 |
| VIIa | 0.0001 | 10 |
| VIII | 0.0003 | 30 |
| IX | 0.09 | 9,000 |
| X | 0.17 | 17,000 |
| XI | 0.025 | 2,500 |
| XII | 0.3 | 30,000 |
| HMWK | 0.9 | 90,000 |
| PK | 0.58 | 58,000 |
| AT | 3.4 | 340,000 |
| TFPI | 0.0025 | 250 |
| Fibrinogen | 8.83 | 883,000 |

The model was tested under (i) conditions in which the type of agents was limited to a small subset of the coagulation factors; or (ii) conditions in which all the coagulation factors were represented. The simulations were designed to test experimental conditions that create interesting thrombin profiles or demonstrate pathology associated with the system. Each simulation was run five times. Comparisons between the ABMS output and experimental data were used to determine the validity of the system.

Both PT and aPTT experiments were terminated when 99% of the initial fibrinogen was converted to fibrin monomers. When running PT experiments, an additional end condition of 135 seconds was defined. This time equates to an INR>10 which is a commonly reported value in clinical laboratories. Similarly, an end condition of 150 seconds was defined for aPTT experiments.

A two tailed student t test was used to compare means between normally distributed values. The alpha level was set at 0.05. The statistical package R v2.7.0 was used for all statistical calculations.

### Results of Computational Simulation

Three sets of simulations were performed to: (i) Validate the model using previously published data and known in vivo and in vitro conditions associated with the intrinsic, extrinsic, and common pathways; (ii) Simulate perturbations of pathways mimicking clinical disease states by measuring prothrombin time (PT) and activated partial thromboplastin time (aPTT); and (iii) Measure the effects of pharmaceutical agents upon these pathways.

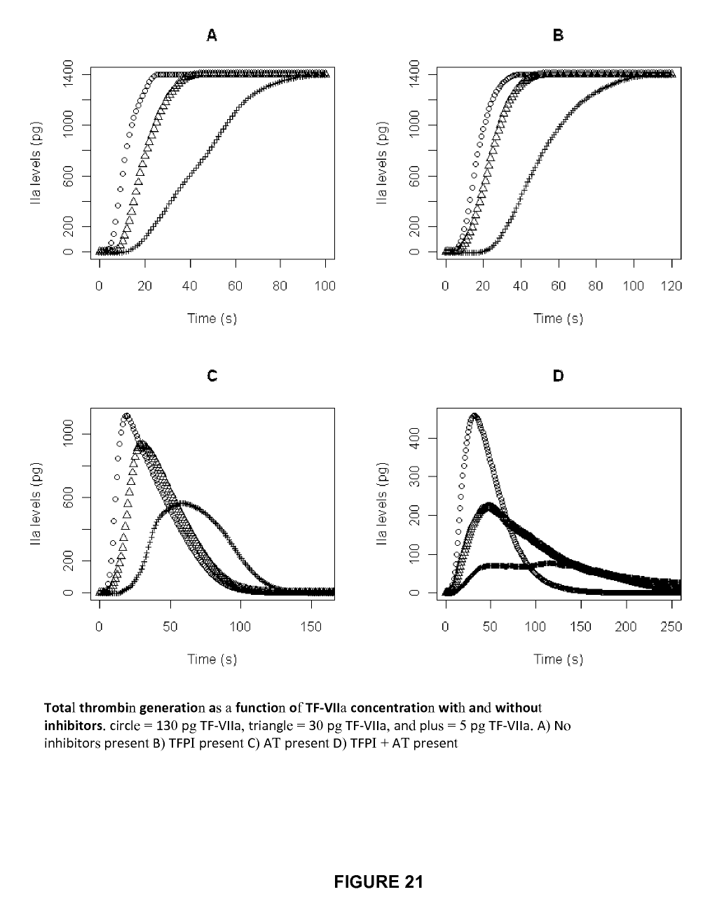

Model validation was performed through the first set of simulations. Through reproduction of the in vitro experiments performed by van't Veer et al. and in silico experiments performed by Hockin et al. the extrinsic portion of the ABMS was analyzed. The simulations were limited to the following agents: TF-VIIa, V, VIII, IX, X, TFPI, and AT. Coagulation was initiated by TF-VIIa at various concentrations (pM range). FIG. 21 demonstrates the effects of increasing VIIa-TF concentrations (5 pM, 30 pM, and 130 pM) that were used to initiate the formation of IIa in the presence and absence of both TFPI and AT. The increasing concentrations resulted in shortening initiation times, arbitrarily defined as the time in seconds

TABLE 9

| | Concentration | | |
|---|---|---|---|
| | 5 pM | 30 pM | 130 pM |
| Time (s) | 9.5 | 6.0 | 3.5 |

Additionally, an increased maximum rate of IIa formation was observed as a function of concentration (Table 10, below).

TABLE 10

| | Concentration | | |
|---|---|---|---|
| | 5 pM | 30 pM | 130 pM |
| Time (s) | 191 | 810 | 1702 |

The threshold dependant formation of IIa in the presence of inhibitors such as AT and TFPI is an important feature of the extrinsic coagulation system. FIG. 21D demonstrates this characteristic profile. At low concentrations of TF-VIIa (5 pM), the threshold value was not reached for producing IIa; whereas both 30 pM and 130 pM concentration were able to generate a short burst of thrombin. These results demonstrate the non-linear nature of the extrinsic pathway to form thrombin that combined with the inhibitors (AT and TFPI) leads to a threshold effect. Elimination of rule 33, generation of thrombin from Xa, or rule 27, generation of Xa from TF-VIIa, suppressed all thrombin formation under all conditions (data not shown).

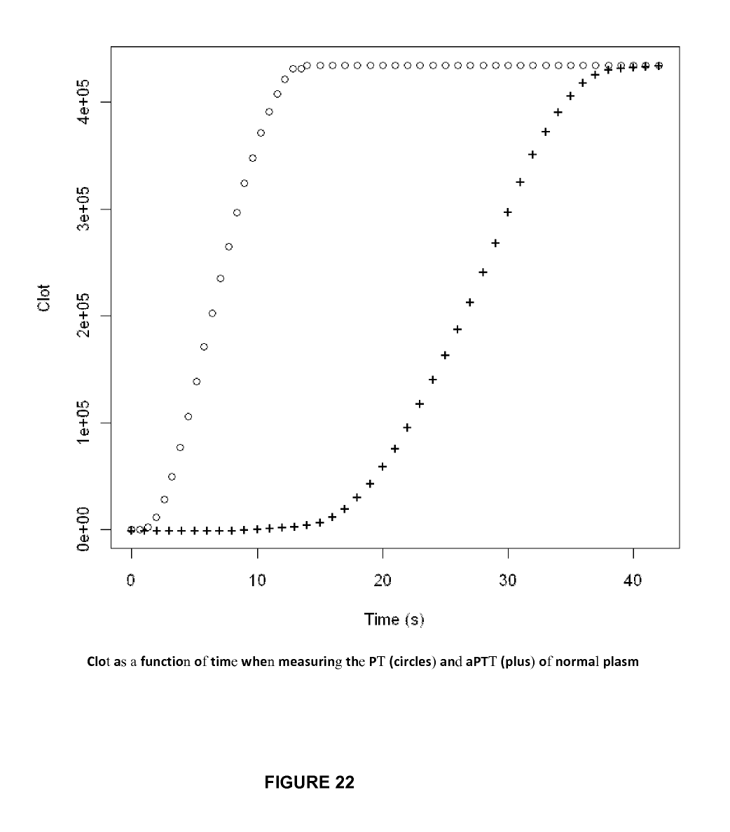

The next test of the extrinsic and the common pathways was simulation of the prothrombin time (PT). In order to initiate coagulation, excess TF was introduced into the system (100,000 agents). The PT assay shows (FIG. 22) three phases of coagulation: initiation, propagation, and termination with a median clotting time of 13.5 s (normal in vitro PT is between 12-15 s. Similarly, the intrinsic system (FIG. 22) was validated by simulating the activated partial thromboplastin time (aPTT). In order to initiate coagulation, the intrinsic pathway was activated by using excess kaolin (100,000 agents) to activate factor XII. The results were similar to the PT assay with the exception of a longer initiation phase (arbitrarily defined as the time needed to form 400 nM of fibrin Table 11, below) and decreased rate of fibrin generation (Table 12, below).

TABLE 11

| aPTT | PT |
|---|---|
| 8.5 s | 1.5 s |

TABLE 12

| aPTT | PT |
|---|---|
| 145,745 nM/s | 255,615 nM/s |

aPTT subsequently takes more time, as compared to the PT, resulting in a longer time until clot formation is observed with a median clotting time of 25.89 s (normal in vitro times 24-40 s). The results are consistent with in vitro assays in which the aPTT takes approximately 2-3 times as long as the PT.

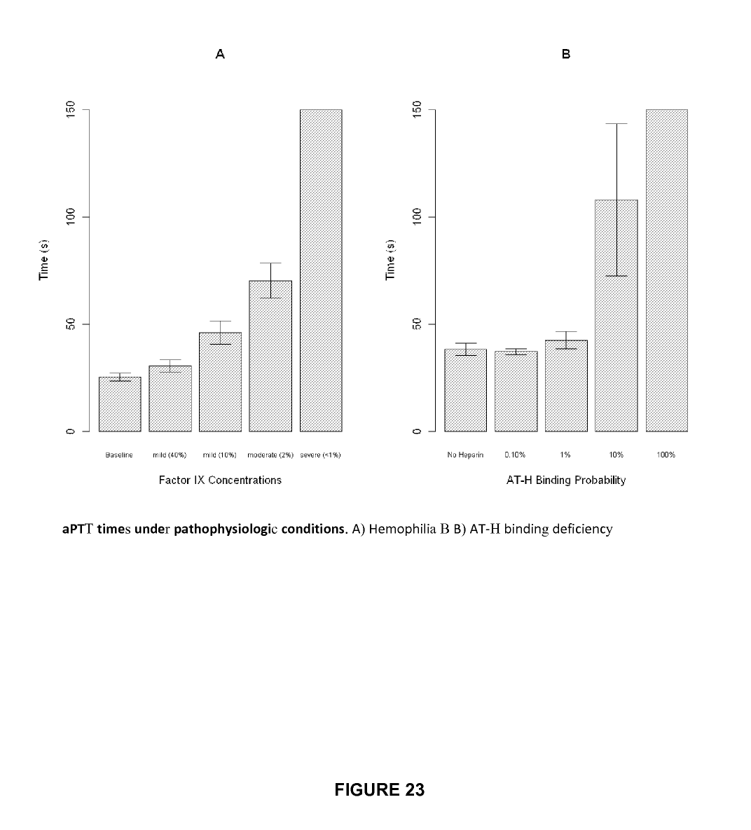

The system was then perturbed by examining the effects of decreased concentration of Factor IX simulating hemophilia B (Christmas disease). Hemophilia B is a disease in which patients have spontaneous hemorrhages and difficulty clotting after minor injuries. Mild hemophilia is defined as Factor IX activity 10-40% of normal with resultant aPTT times that are normal or only slightly increased. FIG. 23A demonstrates the range of aPTT to be between 30-40 s. Moderate hemophilia is defined as factor IX activity between 1 and 10%. Using 2% of normal Factor IX levels gives aPTT times equal to 68.38 s. Severe hemophilia was defined as Factor IX levels greater than about 1%. At this Factor IX concentration, all aPTT times were greater than 150 s at which time the simulations were terminated.

Another interesting clinical condition is one in which AT binding to heparin was impaired. Despite normal plasma AT levels, impaired AT-H binding is associated with a hypercoagable state characterized by an increased risk of thromboembolic disease as well as intrauterine fetal demise (IUFD). This condition was simulated by changing the parameter that determined whether AT and H react when they collide. A concentration of heparin (H300) that leads to impaired clotting was used. FIG. 23B demonstrates the effects of decreasing the AT-H binding probability from 100% to 0.1%. The aPTT time decreased from greater than about 150 sec, in the case of 100% binding, to clotting times that are the equivalent of blood with no heparin, in the cases of 1 and 0.1% binding probability.

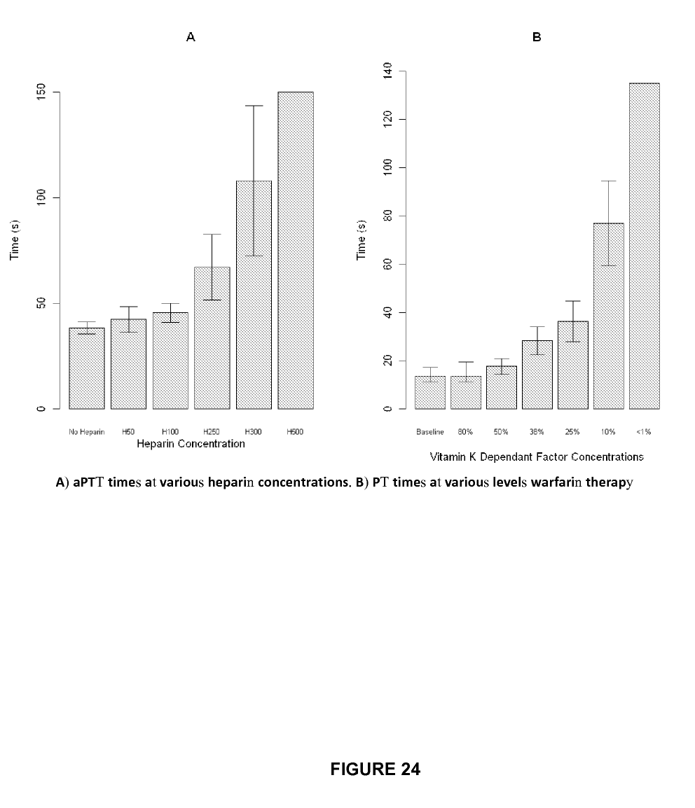

The last important set of simulations measured the effects of pharmaceutical agents upon the coagulation system with outcomes as expected based on clinical experience. These results show that agents. Drugs such as heparin, warfarin, activated Protein C, etc. can easily be simulated using the model. FIG. 24A demonstrates the effects of therapeutic and supra-therapeutic heparin on the aPTT times. Heparin serves to activate AT thereby increasing the reaction rate a thousand-fold. As heparin concentration increases so do the aPTT times until the maximum of 150 s is reached. Similarly, FIG. 24B demonstrates the effects of therapeutic and supra-therapeutic warfarin levels on PT times. The consequences of warfarin administration were simulated by decreasing concentrations of vitamin K dependant factors (II, VII, IX, and X). As expected, decreasing levels of the coagulation factors led to increasing PT times.

The examples given above are merely illustrative and are not meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in molecular biology, computer science, or in the relevant fields are intended to be within the scope of the appended claims.

What is claimed is:

1. A computer system for modeling a coagulation-fibrinolysis-inflammation/immune (CIF) system, the computer system comprising:
one or more processors; and
a computer readable medium in communication with the one or more processors, the computer readable medium having encoded thereon a set of instructions executable by the computer system to perform one or more operations, the set of instructions comprising:
instructions for identifying a plurality of agents involved in the CIF system, each agent representing a molecule in the CIF system and being defined by an identifier and an interaction probability value, the identifier having a value that identifies a type of molecule represented by the agent, and the interaction probability value representing a probability that the agent will react with a neighboring agent;
instructions for arranging the plurality of agents in a computer model, the computer model comprising a plurality of cells and a set of rules that govern behavior of each of the plurality of agents, each cell representing a discrete unit of space; and
instructions for iteratively applying the set of rules to the plurality of agents to simulate the CIF system.

2. The computer system of claim 1, wherein each of plurality of agents has an identifier that identifies that the agent represents one or more molecular or cellular agents of the CIF system selected from the group consisting of a substrate, an enzyme, a reaction product, an inhibitor, a cofactor, endothelial cell, white blood cells, platelets red blood cells, cell membrane receptors, cytokines, chemokines, biological cells, bacteria, viruses, transcription factors, coagulation factors, second messengers, exogenous anticoagulant factors, exogenous procoagulant factors, and a water molecule.

3. The computer system of claim 1, wherein the computer readable medium is an optical magnetic storage device, a magnetic storage device or a disk.

4. The computer system of claim 1, wherein the each cell represents a discrete unit of space in one, two, or three dimensions.

5. The computer system of claim 1, wherein the plurality of cells are arranged in a two or three dimensional grid.

6. A method of developing an agent-based modeling system to model a. coagulation-fibrinolysis-inflammation/immune (CIF) system, said method comprising the steps of:
identifying a plurality of agents involved in the CIF system;
generating, at a computer system, an identifier and interaction probability value for each of the plurality of agents; the identifier having a value that identifies a type of molecule represented by the agent, and the interaction probability value representing a probability that the agent will react with a neighboring agent;
arranging, at the computer system, the plurality of agents in a computer model, the computer model including a plurality of cells, each cell representing a discrete unit of space, and a set of rules that govern behavior of each of the plurality of agents.

7. The method of claim 6, further comprising the step of outputting a result.

8. The method of claim 7, wherein the outputting is displaying the result.

9. The method of claim 6, wherein each cell represents a discrete unit of space in one, two, or three dimensions.

10. The method of claim 6, wherein the plurality of cells are arranged in a two-dimensional grid or a three dimensional grid.

11. The method of claim 10, wherein the computer system models a blood vessel and wherein the two dimensional grid is in a shape of a rectangle or a three dimensional cylinder.

12. The method of claim 11, wherein the computer model simulates blood flow by pulsatile movement of agents through the grid.

13. The method of claim 6, wherein each of the plurality of agents has an identifier with that identifies that agent represents one or more molecular or cellular agents of the CIF system selected from the group consisting of a substrate, an enzyme, a reaction product, an inhibitor, a cofactor, endothelial cell, white blood cells, platelets red blood cells, cell membrane receptors, cytokines, chemokines, biological cells, bacteria, viruses, transcription factors, coagulation factors, second messengers, exogenous anticoagulant factors, exogenous procoagulant factors and a water molecule.

14. The method of claim 6, wherein varying at least of the plurality of agents simulates different conditions of the CIF system.

15. The method of claim 6, wherein the set of rules specify one or more conditions under which an identifier for an agent should be changed from a first value, representing a first type of molecule, to a second value, representing a second type of molecule, based at least in part on the first value of the identifier and values of identifiers of one or more agents located in neighboring cells.

16. The method of claim 6, further comprising the steps of:
producing a simulated CIF system with the computer model;
comparing the simulated CIF system with an empirically-observed CIF system; and
identifying the computer model as a valid computer model based on if the simulated system is substantially consistent with the empirically-observed CIF system.

17. The method of claim 6, wherein the probability value are in a range of about 0.01 to about 1.0.

18. The method of claim 17, wherein the probability value is in a range of about 0.05 to about 0.5.

19. A method of modeling a coagulation-fibrinolysis-inflammation/immune (CIF) system, said method comprising the steps of:
identifying a plurality of agents involved in the CIF system;
generating, at a computer system, an identifier and interaction probability value for each of the plurality of agents; the identifier having a value that identifies a type of molecule represented by the agent, and the interaction probability value representing a probability that the agent will react with a neighboring agent;
arranging, at the computer system, the plurality of agents in a computer model, the computer model comprising a plurality of cells and a set of rules that govern behavior of each of the plurality of agents, each cell representing a discrete unit of space; and
iteratively applying the set of rules to the plurality of agents to simulate a coagulation cascade in the CIF system.

20. The method of claim 19, wherein each iterative application of the set of rules to the plurality of agents represents a discrete unit of time.

21. The method of claim 19. wherein the computer model simulates an initiation, propagation, termination, and lysis of blood clot formation.

22. The method of claim 19, wherein the computer model simulates an effect of one or more conditions selected from the group consisting of infection, systemic inflammation, sepsis, ischemia, cardiac arrest, hemorrhage, hemorrhagic shock, tissue trauma, burns, hemodilution, tissue hypoxia, cardiogenic shock, trauma, acidosis, hyperthermia, and hypothermia on the CIF system.

23. The method of claim 19, wherein the computer model simulates an effect of the immune/inflammatory response on a coagulation system.

24. The method of claim 19, wherein the computer model simulates an effect of the coagulation system on an immune/inflammatory response.

25. The method of claim 19, wherein the computer model is used to identify mediators of the CIF system.

26. The method of claim 19, wherein the computer model is used to a develop treatment regimens for a patient.

27. The method of claim 26, wherein the patient is afflicted with hemophilia, atherosclerosis, cancer, diabetes, lupus, autoimmune disease, acute inflammatory state, a defect in the coagulation system, a defect in the immune/inflammatory response, and a defect in the fibrinolysis system.

28. The method of claim 19, wherein the treatment regimen comprises administering a pharmaceutical agent to the patient.

29. The method of claim 19, wherein the computer model is used to predict side effects of pharmaceutical agents.

30. The method of claim 19, wherein the computer model is used to identify pharmaceutical agents.

31. The method of claim 19, wherein the computer model is used to predict single or multiple organ failure when the single or multiple organs are injured.

32. An apparatus, comprising:
a computer readable medium having encoded thereon a set of instructions executable by a computer system to perform one or more operations, the set of instructions comprising:
instructions for identifying a plurality of agents involved in a coagulation-fibrinolysis-inflammation/immune (CIF) system, each agent representing a molecule in the CIF system and being defined by an identifier and an interaction probability value, the identifier having a value that identifies a type of molecule represented by the agent, and the interaction probability value representing a probability that the agent will react with a neighboring agent;
instructions for arranging the plurality of agents in a computer model, the computer model comprising a plurality of cells and a set of rules that govern behavior of each of the plurality of agents, each cell representing a discrete unit of space; and
instructions for iteratively applying the set of rules to the plurality of agents to simulate a coagulation cascade in the CIF system.
